(19) United States
(12) Patent Application Publication
(10) Pub. No.: US 2024/0241232 A1
(43) Pub. Date: Jul. 18, 2024

(54) IMAGING DEVICE AND IMAGING METHOD

(71) Applicant: Sony Semiconductor Solutions Corporation, Kanagawa (JP)

(72) Inventor: Noboru Sakimura, Tokyo (JP)

(21) Appl. No.: 18/561,960

(22) PCT Filed: Feb. 3, 2022
(86) PCT No.: PCT/JP22/04258

§ 371 Date: Nov. 17, 2023

(30) Foreign Application Priority Data
Jun. 29, 2021 (JP) 2021-108122

(51) Int. Cl. G01S 7/4865

(52) U.S. Cl. CPC G01S 7/4865

(57) ABSTRACT

A photodetection device of the present disclosure includes a light-receiving element, a conversion circuit, and a histogram generation circuit. The light-receiving element is configured to detect a light pulse. The conversion circuit is configured to: generate a first code that sequentially changes during a first period having a first time length in a frame period and that circulates multiple times in units of the first period; generate a second code that sequentially changes during a second period having a second time length in the frame period and that circulates multiple times in units of the second period; generate a first timing code by sampling the first code in accordance with a detection timing of the light pulse; and generate a second timing code by sampling the second code in accordance with the detection timing. The histogram generation circuit is configured to generate a first histogram related to the first timing code and generate a second histogram related to the second timing code.

### TECHNICAL FIELD

The present disclosure relates to a photodetection device, a photodetection system, and a photodetection method that each detect light.

A TOF (Time of Flight) method is often used for measuring a distance to a measurement target. In the ToF method, light is emitted to detect reflected light that is reflected by the measurement target. In addition, in the ToF method, the distance to the measurement target is measured by measuring a time difference between a timing of emitting the light and a timing of detecting the reflected light. For example, PTL 1 discloses a distance measurement device that expands its distance measurement range by causing a TDC (Time to Digital Converter) to operate with first temporal resolution to thereby generate a first histogram, and then causing the TDC to operate with second temporal resolution to thereby generate a second histogram. The second temporal resolution is higher than the first temporal resolution.

### CITATION LIST

### Patent Literature

PTL 1: Japanese Unexamined Patent Application Publication No. 2021-1763

### SUMMARY OF THE INVENTION

Meanwhile, it is desired that a photodetection device be reduced in circuit area, and expectations are placed on a further reduction in the area.

It is desirable to provide a photodetection device, a photodetection system, and a photodetection method that each make it possible to provide a smaller circuit area.

A photodetection device according to an embodiment of the present disclosure includes a light-receiving element, a conversion circuit, and a histogram generation circuit. The light-receiving element is configured to detect a light pulse. The conversion circuit is configured to: generate a first code that sequentially changes over time during a first period having a first time length in a frame period and that circulates multiple times in units of the first period; generate a second code that sequentially changes over time during a second period having a second time length different from the first time length in the frame period and that circulates multiple times in units of the second period; generate a first timing code by sampling the first code in accordance with a detection timing of the light pulse; and generate a second timing code by sampling the second code in accordance with the detection timing. The histogram generation circuit is configured to generate a first histogram related to the first timing code and generate a second histogram related to the second timing code.

A photodetection system according to an embodiment of the present disclosure includes a light-emitting element, a light-receiving element, a conversion circuit, and a histogram generation circuit. The light-emitting element is configured to emit a first light pulse. The light-receiving element is configured to detect a second light pulse corresponding to the first light pulse. The conversion circuit is configured to: generate a first code that sequentially changes over time during a first period having a first time length in a frame period and that circulates multiple times in units of the first period; generate a second code that sequentially changes over time during a second period having a second time length different from the first time length in the frame period and that circulates multiple times in units of the second period; generate a first timing code by sampling the first code in accordance with a detection timing of the second light pulse; and generate a second timing code by sampling the second code in accordance with the detection timing. The histogram generation circuit is configured to generate a first histogram related to the first timing code and generate a second histogram related to the second timing code.

A photodetection method according to an embodiment of the present disclosure includes: emitting a first light pulse; detecting a second light pulse corresponding to the first light pulse; generating a first code that sequentially changes over time during a first period having a first time length in a frame period and that circulates multiple times in units of the first period; generating a second code that sequentially changes over time during a second period having a second time length different from the first time length in the frame period and that circulates multiple times in units of the second period; generating a first timing code by sampling the first code in accordance with a detection timing of the second light pulse; generating a second timing code by sampling the second code in accordance with the detection timing; and generating a first histogram related to the first timing code and a second histogram related to the second timing code.

According to the photodetection device, the photodetection system, and the photodetection method of the embodiments of the present disclosure, the first code is generated that sequentially changes over time during the first period having the first time length in the frame period and that circulates multiple times in units of the first period. In addition, the second code is generated that sequentially changes over time during the second period having the second time length different from the first time length in the frame period and that circulates multiple times in units of the second period. Further, the light pulse is detected, the first timing code is generated by sampling the first code in accordance with the detection timing of the light pulse, and the second timing code is generated by sampling the second code in accordance with the detection timing of the light pulse. Furthermore, the first histogram related to the first timing code is generated, and the second histogram related to the second timing code is generated.

### BRIEF DESCRIPTION OF THE DRAWINGS

FIG. 1 is a block diagram illustrating a configuration example of a photodetection system according to a first embodiment of the present disclosure.

FIG. 2 is an explanatory diagram illustrating a light pattern of light emitted from a light-emitting section illustrated in FIG. 1.

FIG. 3 is a block diagram illustrating a configuration example of a photodetection section illustrated in FIG. 1.

FIG. 4 is a circuit diagram illustrating a configuration example of a macropixel illustrated in FIG. 3.

FIG. 5 is a timing waveform diagram illustrating an operation example of a light-receiving section illustrated in FIG. 4.

FIG. 6 is a circuit diagram illustrating a configuration example of a TDC section and a histogram generation section illustrated in FIG. 4.

FIG. 7 is a timing waveform diagram illustrating an operation example of the photodetection system illustrated in FIG. 1.

FIG. 8 is a timing waveform diagram illustrating an example of counter codes generated by the TDC section illustrated in FIG. 6.

FIG. 9 is another timing waveform diagram illustrating the example of the counter codes generated by the TDC section illustrated in FIG. 6.

FIG. 10 is a timing waveform diagram illustrating an example of histogram generation operation of the photodetection system illustrated in FIG. 1.

FIG. 11A is an explanatory diagram illustrating an example of histograms generated by a histogram generation circuit illustrated in FIG. 6.

FIG. 11B is an explanatory diagram illustrating another example of histograms generated by the histogram generation circuit illustrated in FIG. 6.

FIG. 11C is an explanatory diagram illustrating another example of histograms generated by the histogram generation circuit illustrated in FIG. 6.

FIG. 12 is a flowchart illustrating an operation example of a distance arithmetic section illustrated in FIG. 1.

FIG. 13 is a flowchart illustrating an example of a method of calculating a peak centroid value illustrated in FIG. 12.

FIG. 14 is an explanatory diagram illustrating a specific example of the method of calculating the peak centroid value illustrated in FIG. 13.

FIG. 15 is an explanatory diagram illustrating a specific example of the operation illustrated in FIG. 12.

FIG. 16 is an explanatory diagram illustrating another specific example of the operation illustrated in FIG. 12.

FIG. 17 illustrates an example of counter codes according to a modification example of the first embodiment.

FIG. 18 is a table illustrating an example of characteristics of a photodetection system according to another modification example of the first embodiment.

FIG. 19 is a flowchart illustrating an operation example of a distance arithmetic section according to another modification example of the first embodiment.

FIG. 20 is an explanatory diagram illustrating a specific example of the operation illustrated in FIG. 19.

FIG. 21 is a circuit diagram illustrating a configuration example of a TDC section and a histogram generation section according to another modification example of the first embodiment.

FIG. 22 is a timing waveform diagram illustrating an operation example of a photodetection system according to the other modification example of the first embodiment.

FIG. 23 is a block diagram illustrating a configuration example of a photodetection system according to a second embodiment.

FIG. 24 is a circuit diagram illustrating a configuration example of a TDC section and a histogram generation section according to the second embodiment.

FIG. 25 is a timing waveform diagram illustrating an example of counter codes generated by the TDC section illustrated in FIG. 24.

FIG. 26 is another timing waveform diagram illustrating the example of the counter codes generated by the TDC section illustrated in FIG. 24.

FIG. 27 is a flowchart illustrating an operation example of a distance arithmetic section illustrated in FIG. 23.

FIG. 28 is an explanatory diagram illustrating a specific example of the operation illustrated in FIG. 27.

FIG. 29 is an explanatory diagram illustrating another specific example of the operation illustrated in FIG. 27.

FIG. 30 is a timing waveform diagram illustrating an example of counter codes according to a modification example of the second embodiment.

FIG. 31 is a table illustrating an example of characteristics of a photodetection system according to another modification example of the second embodiment.

FIG. 32 is a circuit diagram illustrating a configuration example of a TDC section and a histogram generation section according to another modification example of the second embodiment.

FIG. 33 is a timing waveform diagram illustrating an operation example of a photodetection system according to the other modification example of the second embodiment.

FIG. 34 is a block diagram illustrating a configuration example of a photodetection system according to an implementation example.

FIG. 35 is a block diagram illustrating a configuration example of a photodetection system according to another implementation example.

FIG. 36 is a block diagram illustrating a configuration example of a photodetection system according to another implementation example.

FIG. 37 is a block diagram depicting an example of schematic configuration of a vehicle control system.

FIG. 38 is a diagram of assistance in explaining an example of installation positions of an outside-vehicle information detecting section and an imaging section.

### MODES FOR CARRYING OUT THE INVENTION

In the following, some embodiments of the present disclosure are described in detail with reference to the drawings. It is to be noted that the description is given in the following order.
1. First Embodiment
2. Second Embodiment
3. Implementation Examples
4. Example of Application to Mobile Body

### 1. First Embodiment

### Configuration Example

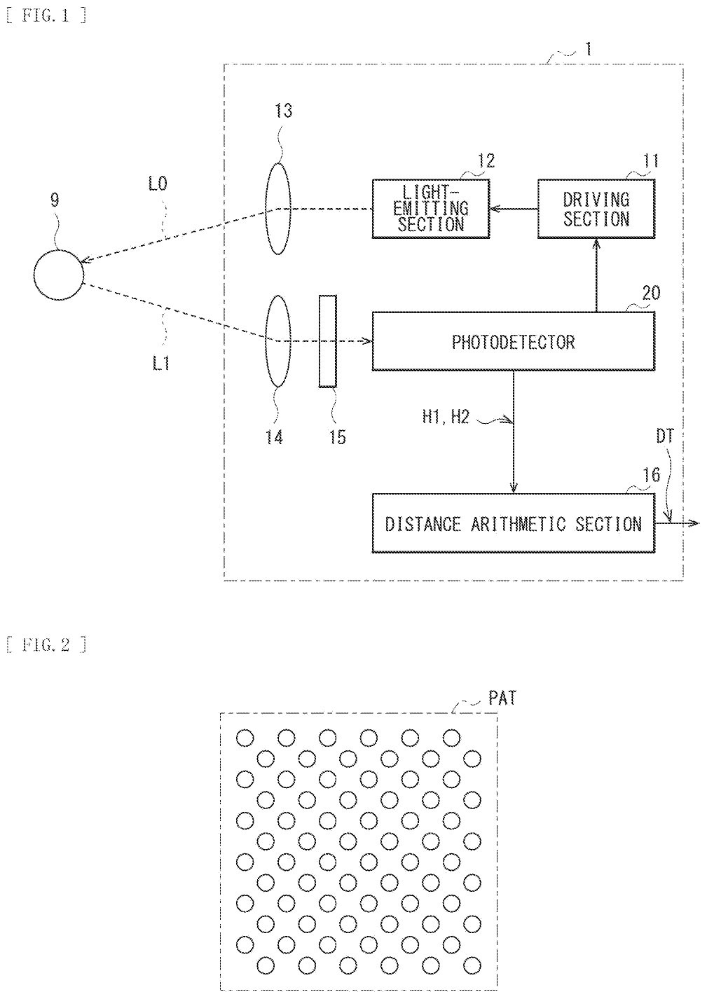

FIG. 1 illustrates a configuration example of a photodetection system (a photodetection system 1) according to a first embodiment. The photodetection system 1 is a ToF sensor, and is configured to emit light and detect reflected light that is reflected by a measurement target. It is to be noted that a photodetection device and a photodetection method according to embodiments of the present disclosure are embodied by the present embodiment, and will be described together below. The photodetection system 1 includes a driving section 11, a light-emitting section 12, a collimator lens 13, a condenser lens 14, a band-pass filter 15, a photodetector 20, and a distance arithmetic section 16.

The driving section 11 is configured to drive the light-emitting section 12 on the basis of an instruction from a control section 24 (to be described later) of the photodetector 20.

The light-emitting section 12 is configured to emit a light pulse L0 toward a measurement target 9 when being driven by the driving section 11. The light-emitting section 12 has a light source that emits infrared light, for example. The light source includes a laser light source, for example. In this example, the laser light source may be a light-emitting element such as a vertical-cavity surface-emitting laser (VCSEL; Vertical Cavity Surface Emitting Laser).

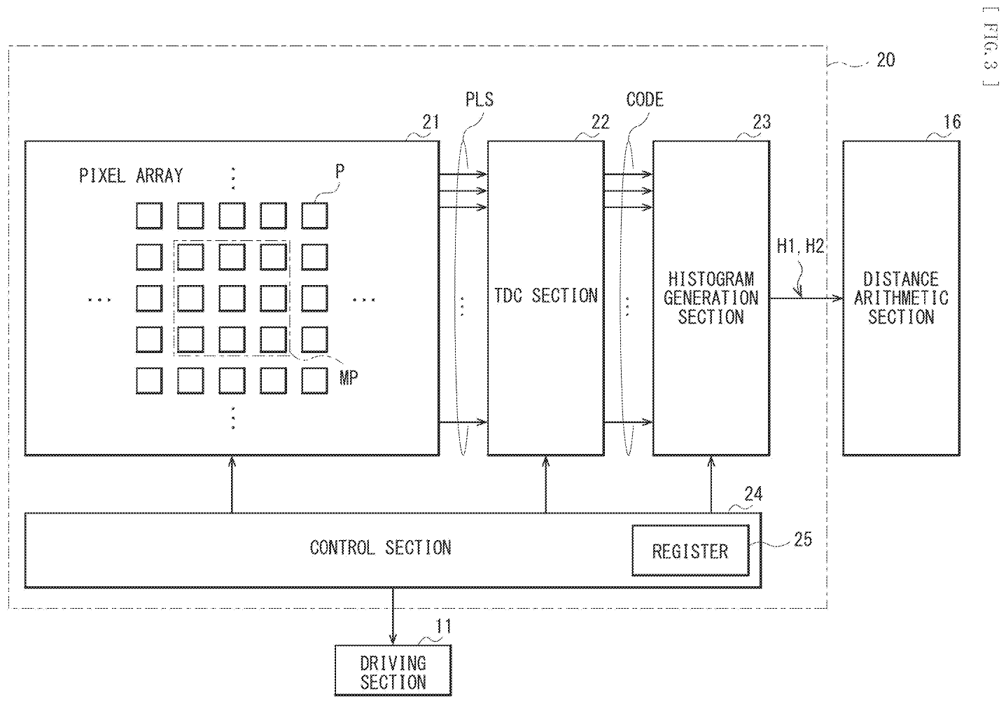

FIG. 2 illustrates a light pattern of the light-emitting section 12. In this example, the light-emitting section 12 includes a plurality of light-emitting elements, and these light-emitting elements emit light pulses. This allows the light-emitting section 12 to emit the light pulse L0 in a light pattern including a plurality of pieces of spot light as illustrated in FIG. 2.

The collimator lens 13 is configured to collimate laser light emitted from the light-emitting section 12 into collimated light. It is to be noted that although the collimator lens 13 is installed in this example, it is possible to install a diffuser instead of the collimator lens 13 in a case of diffusing light.

In such a way, the light pulse L0 emitted from the photodetection system 1 is reflected by the measurement target 9. Next, the light pulse (reflected light pulse L1) reflected by the measurement target 9 enters the photodetection system 1.

The condenser lens 14 is configured to condense the reflected light pulse L1 onto a light-receiving surface of the photodetector 20.

The band-pass filter 15 is configured to selectively transmit an infrared light component included in the reflected light pulse L1 and block components of light other than the infrared light.

The photodetector 20 is configured to detect the reflected light pulse L1 and generate two histograms H1 and H2 related to a detection timing of the reflected light pulse L1. In addition, the photodetector 20 is configured to supply the two histograms H1 and H2 to the distance arithmetic section 16. In addition, the photodetector 20 also has a function of controlling operation of the driving section 11.

FIG. 3 illustrates a configuration example of the photodetector 20. It is to be noted that FIG. 3 also illustrates the driving section 11 and the distance arithmetic section 16 for convenience of description. The photodetector 20 includes a pixel array 21, a TDC section 22, a histogram generation section 23, and a control section 24.

The pixel array 21 includes a plurality of light-receiving sections P arranged in a matrix. The plurality of light-receiving sections P is configured to detect light. In this example, among the plurality of light-receiving sections P, nine light-receiving sections P arranged in three rows and three columns are able to detect one of the plurality of pieces of spot light illustrated in FIG. 2. In other words, for example, a size of the spot light on the light-receiving surface of the pixel array 21 corresponds to a size of the nine light-receiving sections P. The nine light-receiving sections P constitute a macropixel MP.

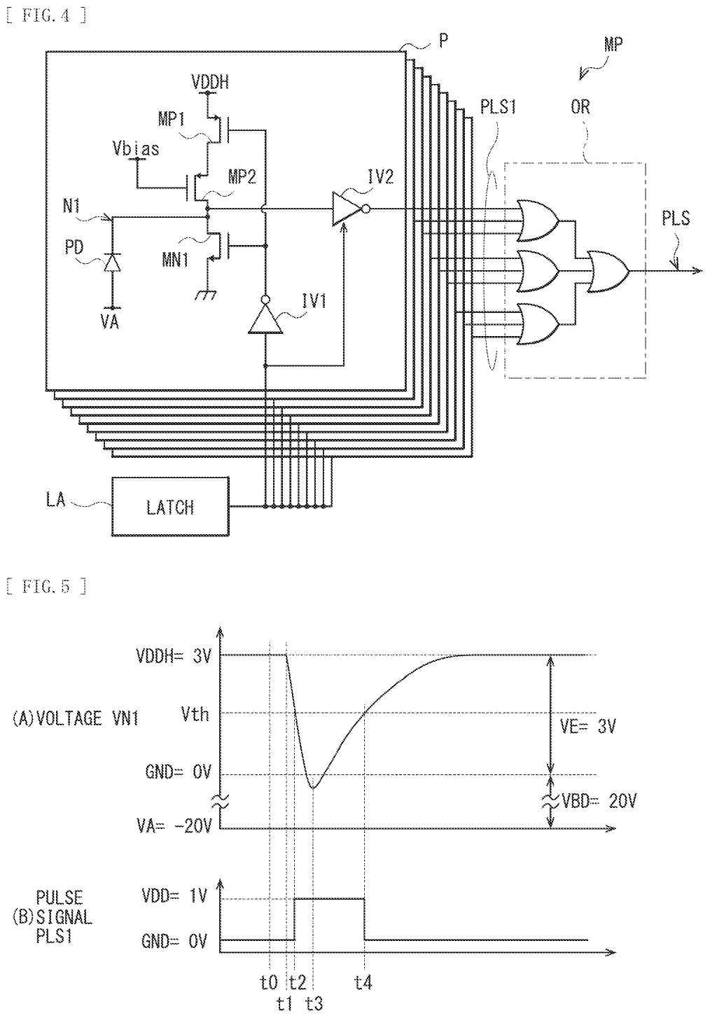

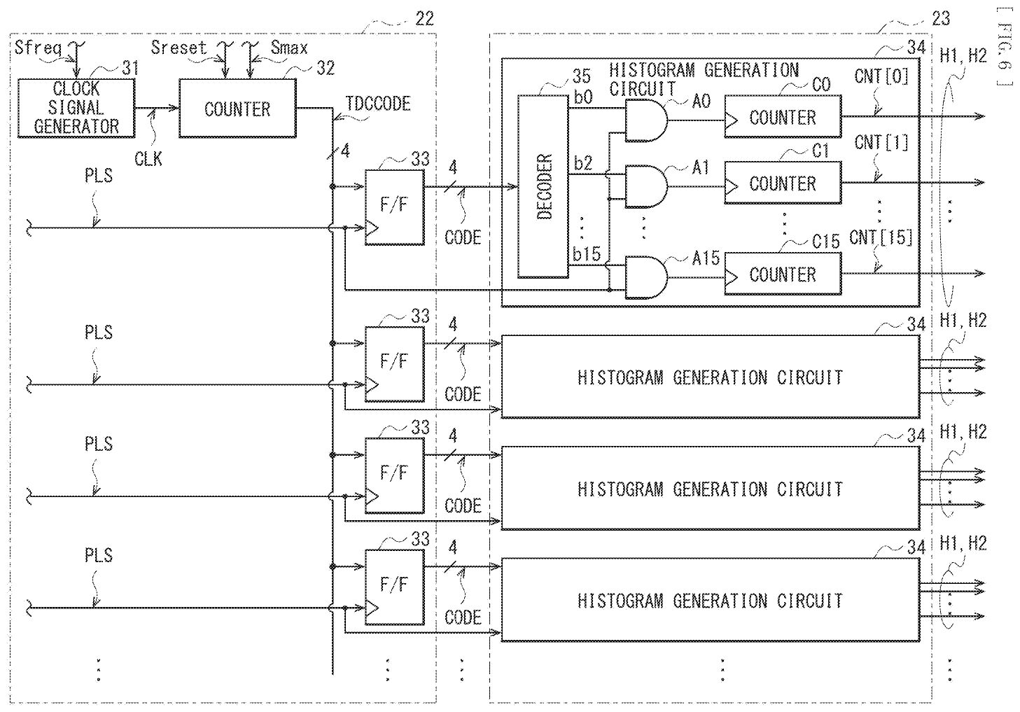

FIG. 4 illustrates a configuration example of the macropixel MP. The macropixel MP includes the nine light-receiving sections P, a latch LA, and an OR circuit OR.

The light-receiving section P includes a photodiode PD, transistors MP1, MP2, and MN1, and inverters IV1 and IV2. The transistors MP1 and MP2 are p-type MOS (Metal Oxide Semiconductor) transistors, and the transistor MN1 is an n-type MOS transistor.

The photodiode PD is a photoelectric conversion element that converts light into electric charge. The photodiode PD has an anode to which voltage VA is supplied, and a cathode coupled to a node N1. In this example, the voltage VA is “−20 V”. Examples of the photodiode PD include a single-photon avalanche diode (SPAD; Single Photon Avalanche Diode).

A gate of the transistor MP1 is coupled to a gate of the transistor MN1 and an output terminal of the inverter IV1. A power source voltage VDDH is supplied to a source of the transistor MP1. A drain of the transistor MP1 is coupled to a source of the transistor MP2. In this example, the power source voltage VDDH is “3 V”. A bias voltage Vbias is supplied to a gate of the transistor MP2. The source of the transistor MP2 is coupled to the drain of the transistor MP1. A drain of the transistor MP2 is coupled to the node N1. The gate of the transistor MN1 is coupled to the gate of the transistor MP1 and the output terminal of the inverter IV1. A drain of the transistor MN1 is coupled to the node N1. A source of the transistor MN1 is grounded.

An input terminal of the inverter IV1 is coupled to an output terminal of the latch LA. The output terminal of the inverter IV1 is coupled to the gates of the transistors MP1 and MN1.

An input terminal of the inverter IV2 is coupled to the node N1. An output terminal of the inverter IV2 is coupled to the OR circuit OR. A control terminal of the inverter IV2 is coupled to the output terminal of the latch LA. The inverter IV2 generates a pulse signal PLS1. In a case where a voltage of the control terminal is high-level, the inverter IV2 operates as an inverter. In a case where the voltage of the control terminal is low-level, the inverter IV2 maintains the pulse signal PLS1 at a low level.

The latch LA is configured to allow for storing of a control signal supplied from the control section 24, for example. The latch LA is coupled to the input terminals of the inverters IV1 and IV2 in the nine light-receiving sections P.

The OR circuit OR is configured to generate a pulse signal PLS by calculating a logical OR of the pulse signals PLS1 supplied from the inverters IV2 of the nine light-receiving sections P.

In a case where an output signal of the latch LA is high-level, the nine light-receiving sections P coupled to the latch LA enter a selected state, and become able to detect the reflected light pulse L1.

FIG. 5 illustrates an operation example of the light-receiving section P in a case where the light-receiving section P is in the selected state. (A) of FIG. 5 illustrates a waveform of a voltage VN1 at the node N1, and (B) of FIG. 5 illustrates a waveform of the pulse signal PLS1.

In the case where the light-receiving section P is in the selected state, the transistor MP1 enters an ON state and the transistor MN1 enters an OFF state. In this case, the transistor MP2 operates as a constant current source. In a case where the photodiode PD has detected no photon, the voltage VN1 at the node N1 is 3 V ((A) of FIG. 5). This voltage VN1 is higher than a logical threshold voltage Vth of the inverter IV2. Therefore, the inverter IV2 sets the pulse signal PLS1 to a low level ((B) of FIG. 5). At this time, the anode of the photodiode PD has a voltage of “−20 V”, and the cathode of the photodiode PD has a voltage of “3 V”. Thus, a cathode-anode voltage of the photodiode PD is higher than a voltage VBD (“20 V”). In such a way, the photodiode PD is set to what is called a Geiger mode.

Next, when a photon enters the photodiode PD at a timing t0 and avalanche amplification occurs at a timing t1, a current flows from the cathode of the photodiode PD toward the anode thereof, and the voltage VN1 falls from 3 V ((A) of FIG. 5). Next, when the voltage VN1 falls below the logical threshold voltage Vth of the inverter IV2 at a timing t2, the inverter IV2 changes the pulse signal PLS1 from the low level to a high level ((B) of FIG. 5).

Next, when the voltage VN1 falls below 0 V and the cathode-anode voltage of the photodiode PD falls below the voltage VBD (“20 V”) at a timing t3 ((A) of FIG. 5), the avalanche amplification stops. Thereafter, when a current flows into the node N1 via the transistor MP2 operating as the constant current source, the voltage VN1 at the node N1 increases. Next, when the voltage VN1 becomes higher than the logical threshold voltage Vth of the inverter IV2, the pulse signal PLS1 changes from the high level to the low level. Next, the voltage VN1 goes back to “3 V”.

In such a way, the light-receiving section P generates the pulse signal PLS1 corresponding to the reflected light pulse L1. Although the operation of the single light-receiving section P has been described in this example, the same applies to the other light-receiving sections P. Next, the OR circuit OR generates the pulse signal PLS by calculating a logical OR of the pulse signals PLS1 generated by the nine light-receiving sections P. Accordingly, in the macropixel MP, the OR circuit OR outputs a pulse as the pulse signal PLS in a case where one or more of the nine light-receiving sections P have detected the reflected light pulse L1. In such a way, the macropixel MP in the selected state generates the pulse signal PLS corresponding to the reflected light pulse L1.

In addition, in a case where the output signal of the latch LA is low-level, the nine light-receiving sections P coupled to the latch LA enter an unselected state, and detect no reflected light pulse L1. In other words, in this case, the transistor MP1 enters the OFF state and the transistor MN1 enters the ON state. The anode of the photodiode PD has a voltage of “−20 V”, and the cathode of the photodiode PD has a voltage of “0 V”. Thus, the cathode-anode voltage of the photodiode PD is equal to the voltage VBD (“20 V”). In such a way, the photodiode PD is set to what is called a non-Geiger mode. In addition, the inverter IV2 maintains the pulse signal PLS1 at the low level because the output signal of the latch LA is low-level. Accordingly, the OR circuit OR maintains the pulse signal PLS at a low level. In such a way, the macropixel MP in the unselected state maintains the pulse signal PLS at the low level.

For example, the photodetection system 1 is able to cause the latch LA of the macropixel MP to store the high level to put the macropixel MP disposed at a position corresponding to the spot light into the selected state. In addition, the photodetection system 1 is able to cause the latch LA of the macropixel MP to store the low level to put the macropixel MP disposed at a position that does not correspond to the spot light into the unselected state. This allows the photodetection system 1 to effectively reduce power consumption.

Although the pixel array 21 includes the OR circuit OR in this example, this is not limitative. For example, the pixel array 21 does not have to include the OR circuit OR, and the OR circuit OR may be interposed between the pixel array 21 and the TDC section 22. In this case, the OR circuit OR may be disposed near the pixel array 21.

It is to be noted that although in this example, the nine light-receiving sections P arranged in three rows and three columns among the plurality of light-receiving sections P detect one of the plurality of pieces of spot light, this is not limitative. Alternatively, for example, four light-receiving sections P arranged in two rows and two columns may detect one of the plurality of pieces of spot light. In this case, the four light-receiving sections P constitute the macropixel MP. Alternatively, for example, sixteen light-receiving sections P arranged in four rows and four columns may detect one of the plurality of pieces of spot light. In this case, the sixteen light-receiving sections P constitute the macropixel MP.

The TDC section 22 (FIG. 3) is configured to generate a timing code CODE corresponding to a detection timing of the reflected light pulse L1 in the macropixel MP on the basis of the pulse signal PLS supplied from the pixel array 21. The TDC section 22 may be disposed near the pixel array 21, or may be disposed in the pixel array 21.

The histogram generation section 23 is configured to generate histograms H1 and H2 related to the detection timing of the reflected light pulse L1 in the macropixel MP on the basis of the timing code CODE supplied from the TDC section 22. The histogram generation section 23 may be disposed near the pixel array 21, or may be disposed in the pixel array 21.

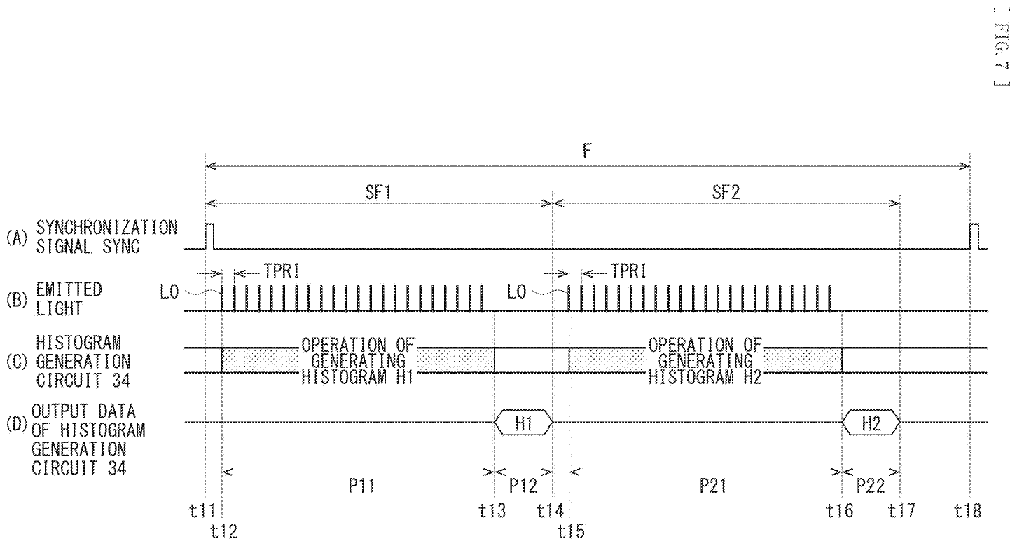

FIG. 6 illustrates a configuration example of the TDC section 22 and the histogram generation section 23.

The TDC section 22 includes a clock signal generator 31, a counter 32, and a plurality of flip-flops (F/F) 33.

The clock signal generator 31 is configured to generate a clock signal CLK. The clock signal generator 31 includes a phase-locked loop circuit (PLL: Phase Locked Loop), for example. The clock signal generator 31 is able to change a frequency of the clock signal CLK on the basis of a control signal Sfreq supplied from the control section 24.

The counter 32 is configured to generate a counter code TDCCODE by performing a counting operation on the basis of the clock signal CLK. In this example, the counter code TDCCODE is a binary code of multiple bits (4 bits in this example). The counter 32 resets the counter code TDCCODE on the basis of a control signal Sreset supplied from the control section 24 (FIG. 3). In addition, the counter 32 is adapted to set a maximum value of the counter code TDCCODE on the basis of a control signal Smax supplied from the control section 24. This allows the counter 32 to perform the counting operation in such a manner that the counter code TDCCODE has a value that circulates in a range from “0” to the maximum value indicated by the control signal Smax. Specifically, in a case where the control signal Smax indicates “15”, the counter 32 performs the counting operation in such a manner that the counter code TDCCODE has a value that circulates in a range of “0” or more and “15” or less. Alternatively, in a case where the control signal Smax indicates “13”, the counter 32 performs the counting operation in such a manner that the counter code TDCCODE has a value that circulates in a range of “0” or more and “13” or less.

The plurality of flip-flops 33 is provided in correspondence with a respective plurality of pulse signals PLS. Each of the plurality of flip-flops 33 is configured to generate the timing code CODE of multiple bits (4 bits in this example) by sampling the counter code TDCCODE of multiple bits (4 bits in this example) on the basis of a rising edge of the pulse signal PLS.

Such a configuration allows the TDC section 22 to generate the timing code CODE corresponding to the detection timing of the reflected light pulse L1 in the macropixel MP on the basis of the pulse signal PLS generated by the macropixel MP.

The histogram generation section 23 includes a plurality of histogram generation circuits 34. Each of the plurality of histogram generation circuits 34 is configured to generate, on the basis of the timing code CODE and the pulse signal PLS relevant to a single macropixel MP, the histograms H1 and H2 related to the timing code CODE relevant to the macropixel MP. The histogram generation circuit 34 includes a decoder 35, a plurality of AND circuits (sixteen AND circuits A0 to A15 in this example), and a plurality of counters (sixteen counters C0 to C15 in this example).

The decoder 35 is configured to generate a plurality of signals (sixteen signals b0 to b15 in this example) by decoding the timing code CODE of multiple bits (4 bits in this example). For example, in a case where the timing code CODE is “0000”, the decoder 35 sets the signal b0 to “1” and sets the other signals b1 to b15 to “0”. For example, in a case where the timing code CODE is “0001”, the decoder 35 sets the signal b1 to “1” and sets the other signals b0 and b2 to b15 to “0”. For example, in a case where the timing code CODE is “1111”, the decoder 35 sets the signal b15 to “1” and sets the other signals b0 to b14 to “0”.

The AND circuit A0 is configured to calculate a logical AND of the pulse signals PLS and the signal b0 supplied from the decoder 35. The counter C0 is configured to generate a count value CNT[0] by performing the counting operation on the basis of a rising edge of an output signal from the AND circuit A0. The AND circuit A1 is configured to calculate a logical AND of the pulse signals PLS and the signal b1 supplied from the decoder 35. The counter C1 is configured to generate a count value CNT[1] by performing the counting operation on the basis of a rising edge of an output signal from the AND circuit A1. The same applies to the AND circuits A2 to A15 and the counters C2 to C15.

With such a configuration, for example, in a case where the value indicated by the timing code CODE is “3”, the decoder 35 sets the signal b3 to “1” and sets the other signals b0 to b2 and b4 to b15 to “0”. Therefore, the AND circuit A3 generates a pulse on the basis of the signal b3 and the pulse signal PLS. The counter C3 increments a count value CNT[3] on the basis of the pulse. The histogram generation circuit 34 performs the above-described operation each time the timing code CODE is supplied. In such a way, the histogram generation circuit 34 generates count values CNT[0] to CNT[15]. The count values CNT[0] to CNT[15] constitute the histograms H1 and H2. Specifically, in this example, in a case where the control signal Smax supplied to the TDC section 22 is “15”, the count values CNT[0] to CNT[15] generated by the histogram generation circuit 34 constitute the histogram H1. Alternatively, in a case where the control signal Smax supplied to the TDC section 22 is “13”, the count values CNT[0] to CNT[15] generated by the histogram generation circuit 34 constitute the histogram H2.

In such a way, the histogram generation section 23 generates the histograms H1 and H2 related to the detection timing of the reflected light pulse L1 in the macropixel MP on the basis of the timing code CODE supplied from the TDC section 22. Next, as illustrated in FIGS. 1 and 3, the histogram generation section 23 supplies the generated histograms H1 and H2 to the distance arithmetic section 16.

The control section 24 (FIG. 3) is adapted to control operation of the photodetection system 1 by supplying control signals to the pixel array 21, the TDC section 22, the histogram generation section 23, and the driving section 11. The control section 24 includes a register 25. The register 25 stores various kinds of setting data for the photodetection system 1. The register 25 is externally accessible and allows for rewriting of the setting data. This makes it possible for the photodetection system 1 to operate on the basis of rewritten setting data.

The distance arithmetic section 16 (FIG. 1) is configured to calculate a distance value of a distance between the photodetection system 1 and the measurement target 9 on the basis of the histograms H1 and H2 related to the macropixel MP. In addition, the distance arithmetic section 16 generates distance data DT including data of respective distance values of the plurality of macropixels MP.

Here, the photodiode PD corresponds to a specific example of a “light-receiving element” according to the present disclosure. The TDC section 22 corresponds to a specific example of a “conversion circuit” according to the present disclosure. The histogram generation section 23 corresponds to a specific example of a “histogram generation circuit” according to the present disclosure. The distance arithmetic section 16 corresponds to a specific example of an “arithmetic circuit” according to the present disclosure.

### Operation and Workings

Next, a description will be given of operation and workings of the photodetection system 1 according to the present embodiment.

### Outline of Overall Operation

First, with reference to FIGS. 1 and 3, an outline of overall operation of the photodetection system 1 will be described. The driving section 11 drives the light-emitting section 12 on the basis of an instruction from the control section 24 of the photodetector 20. Being driven by the driving section 11, the light-emitting section 12 emits the light pulse L0 toward the measurement target 9. The collimator lens 13 collimates laser light emitted from the light-emitting section 12 into collimated light. The light pulse L0 emitted from the photodetection system 1 is reflected by the measurement target 9. Next, the light pulse (the reflected light pulse L1) reflected by the measurement target 9 enters the photodetection system 1. The condenser lens 14 condenses the reflected light pulse L1 onto the light-receiving surface of the photodetector 20. The band-pass filter 15 selectively transmits an infrared light component included in the reflected light pulse L1 and blocks components of light other than the infrared light.

In the pixel array 21, the macropixel MP generates the pulse signal PLS by detecting the reflected light pulse L1. The TDC section 22 generates the timing code CODE corresponding to the detection timing of the reflected light pulse L1 in the macropixel MP on the basis of the pulse signal PLS. The histogram generation section 23 generates the histograms H1 and H2 related to the detection timing of the reflected light pulse L1 in the macropixel MP on the basis of the timing code CODE supplied from the TDC section 22. The control section 24 controls operation of the photodetection system 1 by supplying control signals to the pixel array 21, the TDC section 22, the histogram generation section 23, and the driving section 11.

The distance arithmetic section 16 is configured to calculate the distance value of the distance between the photodetection system 1 and the measurement target 9 on the basis of the histograms H1 and H2 related to the macropixel MP. In addition, the distance arithmetic section 16 generates the distance data DT including data of respective distance values of the plurality of macropixels MP.

### Detailed Operation

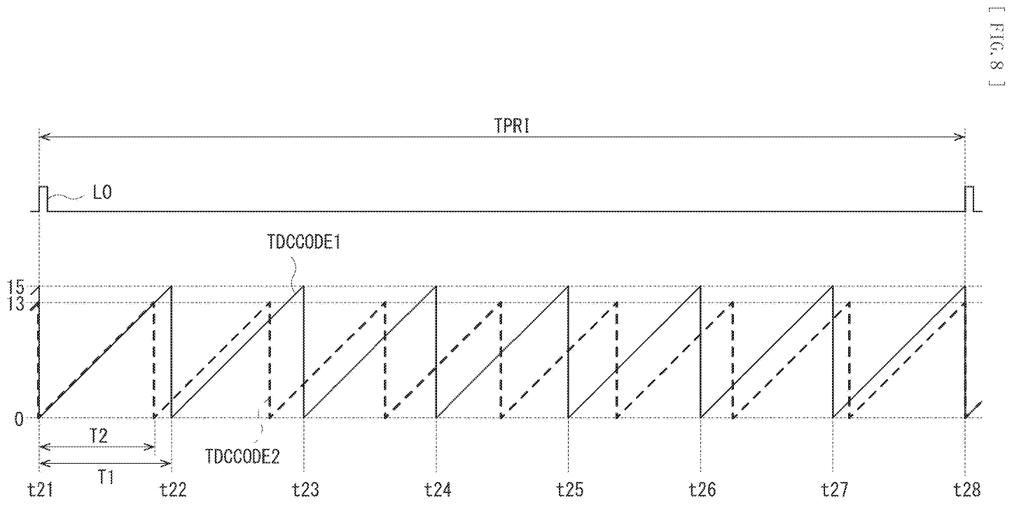

FIG. 7 illustrates an operation example of the photodetection system 1. (A) of FIG. 7 illustrates a waveform of a synchronization signal SYNC. (B) of FIG. 7 illustrates a waveform of light emitted from the light-emitting section 12. (C) of FIG. 7 illustrates operation of the histogram generation circuit 34. (D) of FIG. 7 illustrates output data of the histogram generation circuit 34.

A frame period F is started by a pulse of the synchronization signal SYNC at a timing t11 ((A) of FIG. 7). During a period from the timing t11 to a timing t14 (a sub-frame period SF1) in the frame period F, the control section 24 uses the control signal Smax to instruct the counter 32 of the TDC section 22 to perform the counting operation in the range of “0” or more and “15” or less.

Next, during a period from a timing t12 to a timing t13 (an exposure period P11), the light-emitting section 12 repeatedly emits the light pulse L0 in a predetermined cycle in units of unit exposure period TPRI ((B) of FIG. 7). The reflected light pulse L1 based on the light pulse L0 repeatedly enters the photodetection system 1. The macropixel MP generates the pulse signal PLS by detecting the reflected light pulses L1. The pulse signal PLS includes a plurality of pulses generated each time the macropixel MP detects the reflected light pulse L1. The counter 32 of the TDC section 22 performs the counting operation in such a manner that the counter code TDCCODE (a counter code TDCCODE1) has a value that circulates in the range of “0” or more and “15” or less. Next, the flip-flop 33 of the TDC section 22 repeatedly generates the timing code CODE (a timing code CODE1) corresponding to the detection timing of the reflected light pulse L1 in the macropixel MP by sampling the counter code TDCCODE1 on the basis of the pulse signal PLS. Next, during the exposure period P11, the histogram generation circuit 34 generates the histogram H1 on the basis of the plurality of timing codes CODE1 ((C) of FIG. 7).

Next, during a period from the timing t13 to the timing t14 (an output period P12), the histogram generation circuit 34 outputs the generated histogram H1 to the distance arithmetic section 16 ((D) of FIG. 7).

Next, during a period from the timing t14 to a timing t17 (a sub-frame period SF2), the control section 24 uses the control signal Smax to instruct the counter 32 of the TDC section 22 to perform the counting operation in the range of “0” or more and “13” or less.

Next, during a period from a timing t15 to a timing t16 (an exposure period P21), the light-emitting section 12 repeatedly emits the light pulse L0 in a predetermined cycle in units of the unit exposure period TPRI ((B) of FIG. 7). Next, the reflected light pulse L1 based on the light pulse L0 repeatedly enters the photodetection system 1. The macropixel MP generates the pulse signal PLS by detecting the reflected light pulses L1. The pulse signal PLS includes a plurality of pulses generated each time the macropixel MP detects the reflected light pulse L1. The counter 32 of the TDC section 22 performs the counting operation in such a manner that the counter code TDCCODE (a counter code TDCCODE2) has a value that circulates in the range of “0” or more and “13” or less. The flip-flop 33 of the TDC section 22 repeatedly generates the timing code CODE (a timing code CODE2) corresponding to the detection timing of the reflected light pulse L1 in the macropixel MP by sampling the counter code TDCCODE2 on the basis of the pulse signal PLS. In addition, during the exposure period P21, the histogram generation circuit 34 generates the histogram H2 on the basis of the plurality of timing codes CODE2 ((C) of FIG. 7). For example, a length of the exposure period P21 may be set to be the same as a length of the exposure period P11.

Next, during a period from the timing t16 to the timing t17 (an output period P22), the histogram generation circuit 34 outputs the generated histogram H2 to the distance arithmetic section 16 ((D) of FIG. 7).

Thereafter, at a timing t18, the frame period F ends and a new frame period F starts. The photodetection system 1 repeats the operations performed from the timing t11 to the timing t18 at a predetermined frame rate. For example, the frame rate may be set to 30 fps.

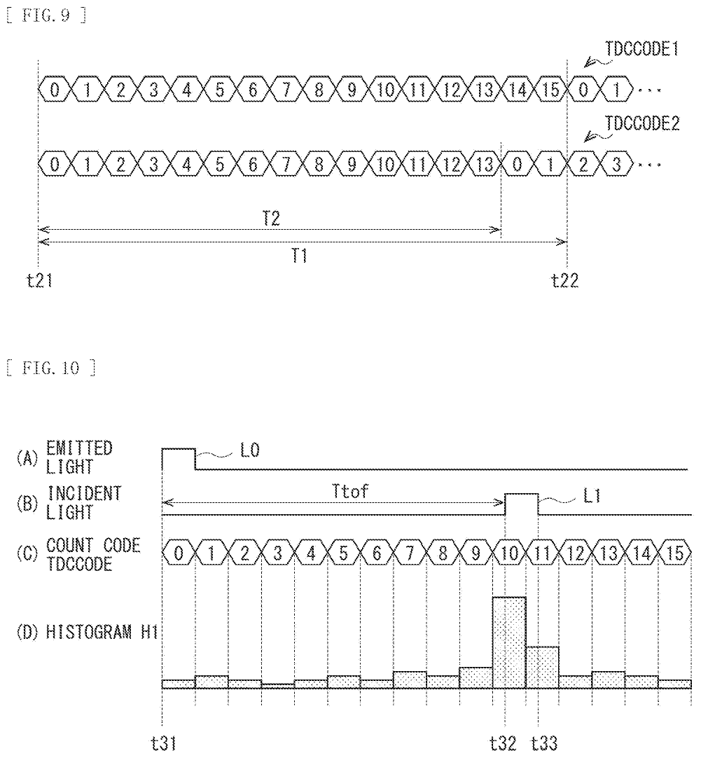

FIGS. 8 and 9 illustrate an operation example of the counter 32 in the unit exposure period TPRI. As illustrated in FIG. 7, the sub-frame period SF1 and the sub-frame period SF2 are different from each other; however, FIGS. 8 and 9 illustrate the counter codes TDCCODE1 and TDCCODE2 in an overlapping manner within the same time scale.

The counter code TDCCODE1 circulates in the range of “0” or more and “15” or less. Specifically, the counter code TDCCODE1 sequentially changes from “0” to “15” during each of a plurality of periods T1 in the sub-frame period SF1. Specifically, the counter code TDCCODE1 sequentially changes from “0” to “15” during each of a period from a timing t21 to a timing t22, a period from the timing t22 to a timing t23, a period from the timing t23 to a timing t24, a period from the timing t24 to a timing t25, a period from the timing t25 to a timing t26, a period from the timing t26 to a timing t27, and a period from the timing t27 to a timing t28. The counter code TDCCODE1 can take any of the values of “0” or more and “15” or less. Therefore, the number of possible values of the counter code TDCCODE1 is 16. The counter code TDCCODE1 circulates seven times during the unit exposure period TPRI.

In addition, the counter code TDCCODE2 circulates in the range of “0” or more and “13” or less. Specifically, the counter code TDCCODE2 sequentially changes from “0” to “13” during each of a plurality of periods T2 in the sub-frame period SF2. The counter code TDCCODE2 can take any of the values of “0” or more and “13” or less. Therefore, the number of possible values of counter code TDCCODE2 is 14. The counter code TDCCODE2 circulates eight times during the unit exposure period TPRI.

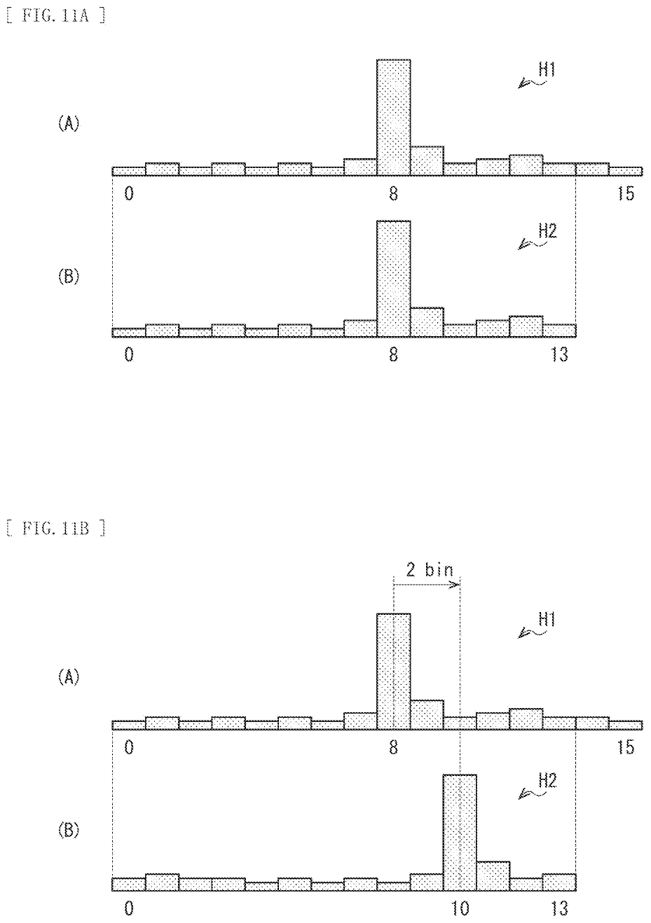

FIG. 10 illustrates an operation example of the photodetection system 1 in the sub-frame period SF1. During the sub-frame period SF1, the control section 24 uses the control signal Smax to instruct the counter 32 of the TDC section 22 to perform the counting operation in the range of “0” or more and “15” or less.

In this example, the light-emitting section 12 emits the light pulse L0 at a timing t31 ((A) of FIG. 10). At the timing t31, the counter 32 of the TDC section 22 resets the counter code TDCCODE (the counter code TDCCODE1) on the basis of the control signal Sreset, and starts the counting operation in such a manner that the counter code TDCCODE1 has a value that circulates in the range of “0” or more and “15” or less ((C) of FIG. 10). In this example, the light pulse L0 has a pulse width that is similar to an update cycle of the counter code TDCCODE1. The update cycle of the counter code TDCCODE1 corresponds to temporal resolution in a conversion process performed by the TDC section 22.

The light pulse L0 emitted from the photodetection system 1 is reflected by the measurement target 9, and the light pulse (the reflected light pulse L1) reflected by the measurement target 9 enters the photodetection system 1 ((B) of FIG. 10). In this example, the reflected light pulse L1 is generated during a period from a timing t32 to a timing t33. A time from a timing t30 to a timing t32 corresponds to a time of flight Ttof of a light pulse that travels between the photodetection system 1 and the measurement target 9 in a round-trip manner.

The macropixel MP generates the pulse signal PLS on the basis of the reflected light pulse L1. The flip-flop 33 of the TDC section 22 generates the timing code CODE (the timing code CODE1) corresponding to the detection timing of the reflected light pulse L1 in the macropixel MP by sampling the counter code TDCCODE1 on the basis of the pulse signal PLS.

For example, the timing code CODE1 may be “10” in a case where the photodiode PD detects a photon in a period where the counter code TDCCODE1 is “10”. In this case, a counter C10 of the histogram generation circuit 34 increments a count value CNT[10]. In addition, for example, the timing code CODE1 may be “11” in a case where the photodiode PD detects a photon in a period where the counter code TDCCODE1 is “11”. In this case, a counter C11 of the histogram generation circuit 34 increments a count value CNT[11]. The photodetection system 1 generates the histogram H1 by repeating the above-described operation multiple times ((D) of FIG. 10). The counter code TDCCODE1 can take any of the values of “0” or more and “15” or less. Therefore, the number of bins in the histogram H1 is “16”. The histogram H1 has a higher count value CNT (frequency value) at a position corresponding to the detection timing of the reflected light pulse L1. In such a way, the histogram H1 has a peak.

It is to be noted that in this example, the description has been given of the operation of the photodetection system 1 performed during the sub-frame period SF1 as an example. The same applies to operation performed during the sub-frame period SF2. During the sub-frame period SF2, the counter 32 of the TDC section 22 performs the counting operation in such a manner that the counter code TDCCODE (the counter code TDCCODE2) has a value that circulates in the range of “0” or more and “13” or less. This allows the photodetection system 1 to generate the histogram H2. The counter code TDCCODE2 can take any of the values of “0” or more and “13” or less. Therefore, the number of bins in the histogram H2 is “14”.

As illustrated in FIGS. 8 and 9, a length of the period T1 as a unit of circulation of the counter code TDCCODE1 and a length of the period T2 as a unit of circulation of the counter code TDCCODE2 are different from each other. Therefore, a relationship between a peak position in the histogram H1 and a peak position in the histogram H2 changes depending on which of periods within a period from the timing t21 to the timing t28 the reflected light pulse L1 enters the photodiode PD in.

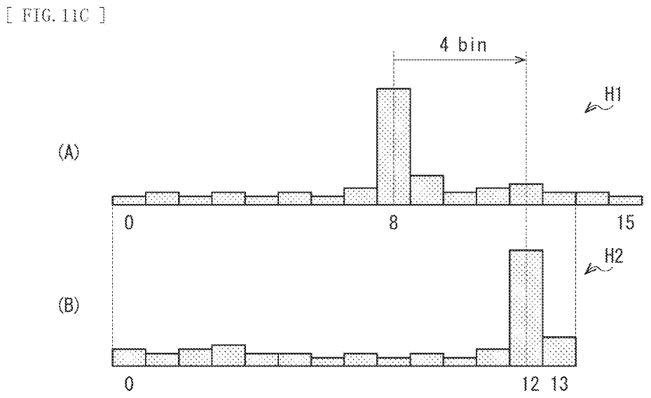

FIGS. 11A to 11C illustrate examples of the histograms H1 and H2. In each of FIGS. 11A to 11C, (A) illustrates the histogram H1, and (B) illustrates the histogram H2.

For example, in a case where the reflected light pulse L1 enters the photodiode PD in the period from the timing t21 to the timing t22 in FIG. 8, the peak position of the histogram H2 is almost same as the peak position of the histogram H1, as illustrated in FIG. 11A. In other words, an amount of difference between the peak positions (a peak shift value) is almost “0”.

In contrast, for example, in a case where the reflected light pulse L1 enters the photodiode PD in the period from the timing t22 to the timing t23 in FIG. 8, the peak position of the histogram H2 is shifted from the peak position of the histogram H1 to the right by about two bins, as illustrated in FIG. 11B. In other words, the peak shift value is about “2” in units of bin width.

In addition, for example, in a case where the reflected light pulse L1 enters the photodiode PD in the period from the timing t23 to the timing t24 in FIG. 8, the peak position of the histogram H2 is shifted from the peak position of the histogram H1 to the right by about four bins, as illustrated in FIG. 11C. In other words, the peak shift value is about “4” in units of bin width.

As described above, the relationship between the peak position in the histogram H1 and the peak position in the histogram H2 changes depending on which of periods within the period from the timing t21 to the timing t28 the reflected light pulse L1 enters the photodiode PD in. For example, in the case where the reflected light pulse L1 enters between the timing t21 and the timing t22, the peak shift vale is almost “0”. In the case where the reflected light pulse L1 enters between the timing t22 and the timing t23, the peak shift vale is about “2”. In the case where the reflected light pulse L1 enters between the timing t23 and the timing t24, the peak shift vale is about “4”. In such a manner, the peak shift value changes by “2” depending on the period in which the reflected light pulse L1 enters. The amount of change in the peak shift value corresponds to a difference between the number of bins in the histogram H1 (“16” in this example) and the number of bins in the histogram H2 (“14” in this example). The distance arithmetic section 16 determines such a peak shift value and this makes it possible for the distance arithmetic section 16 to determine which of the period from the timing t21 to the timing t22, the period from the timing t22 to the timing t23, the period from the timing t23 to the timing t24, the period from the timing t24 to the timing t25, the period from the timing t25 to the timing t26, the period from the timing t26 to the timing t27, and the period from the timing t27 to the timing t28 the reflected light pulse L1 has entered the photodiode PD in. In other words, the distance arithmetic section 16 is able to distinguish among seven distance ranges by determining such peak shift values.

This makes it possible for the photodetection system 1 to widen its distance measurement range. In other words, supposing the counter code TDCCODE2 is not used and only the counter code TDCCODE1 is used, the photodetection system is unable to make a distinction between the detection timing of the reflected light pulse L1 that enters in the period from the timing t21 to the timing t22 and the detection timing of the reflected light pulse L1 that enters in, for example, the period from the timing t22 to the timing t23. Thus, the photodetection system is to perform a distance measurement operation on the basis of the detection timing of the reflected light pulse 1 that enters in the period from the timing t21 to the timing t22. This results in a narrower distance measurement range. In contrast, the photodetection system 1 according to the present embodiment is able to perform the distance measurement operation on the basis of the detection timing of the reflected light pulse 1 that enters in the period from the timing t21 to the timing t28. This makes it possible for the photodetection system 1 to widen the distance measurement range to sevenfold that in the case of using only the counter code TDCCODE1 without using the counter code TDCCODE2. It is thus possible for the photodetection system 1 to widen the distance measurement range while increasing temporal resolution.

Here, the period T1 corresponds to a specific example of a “first period” according to the present disclosure. The counter code TDCCODE1 corresponds to a specific example of a “first code” according to the present disclosure. The counter code TDCCODE2 corresponds to a specific example of a “second code” according to the present disclosure. The timing code CODE1 corresponds to a specific example of a “first timing code” according to the present disclosure. The timing code CODE2 corresponds to a specific example of a “second timing code” according to the present disclosure. The histogram H1 corresponds to a specific example of a “first histogram” according to the present disclosure. The histogram H2 corresponds to a specific example of a “second histogram” according to the present disclosure. The exposure period P11 corresponds to a specific example of a “first exposure period” according to the present disclosure. The unit exposure period TPRI in the exposure period P11 corresponds to a specific example of a “first unit exposure period” according to the present disclosure. The exposure period P21 corresponds to a specific example of a “second exposure period” according to the present disclosure. The unit exposure period TPRI in the exposure period P21 corresponds to a specific example of a “second unit exposure period” according to the present disclosure.

Next, a detailed description will be given of operations of the distance arithmetic section 16 to calculate the distance value on the basis of the histograms H1 and H2.

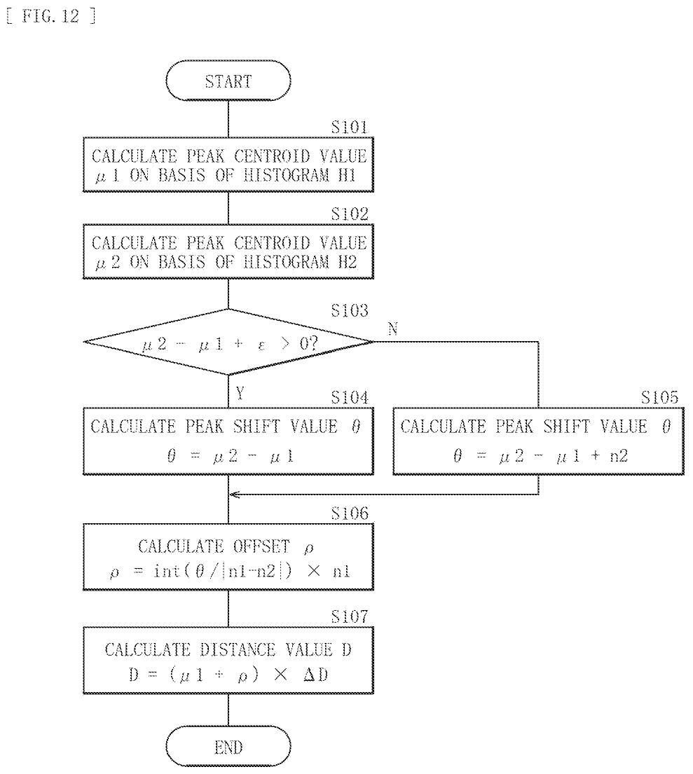

FIG. 12 illustrates an operation example of the distance arithmetic section 16.

First, on the basis of the histogram H1, the distance arithmetic section 16 calculates a peak centroid value μ1 indicating the peak position of the histogram H1 (step S101).

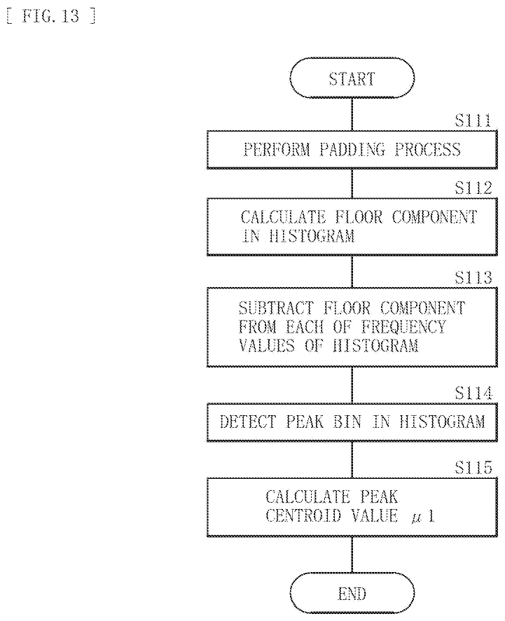

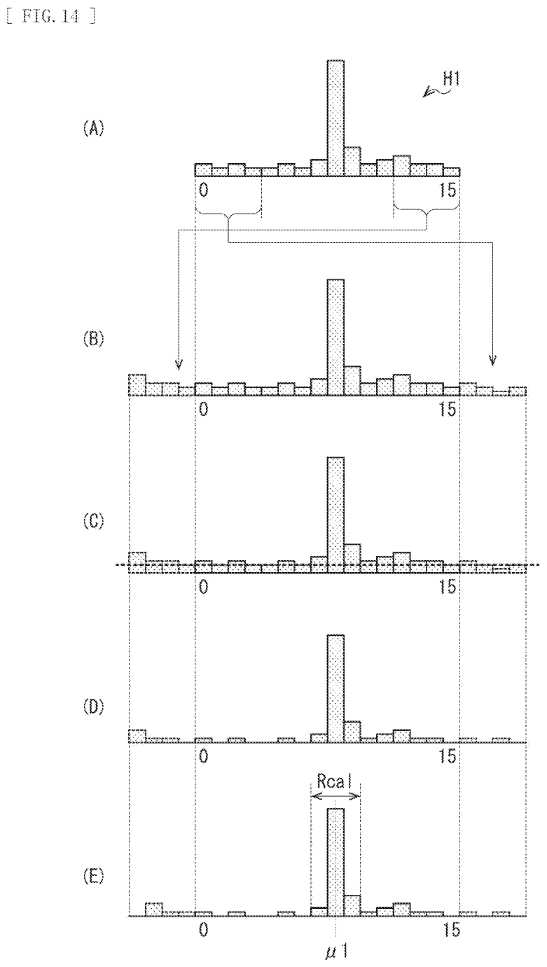

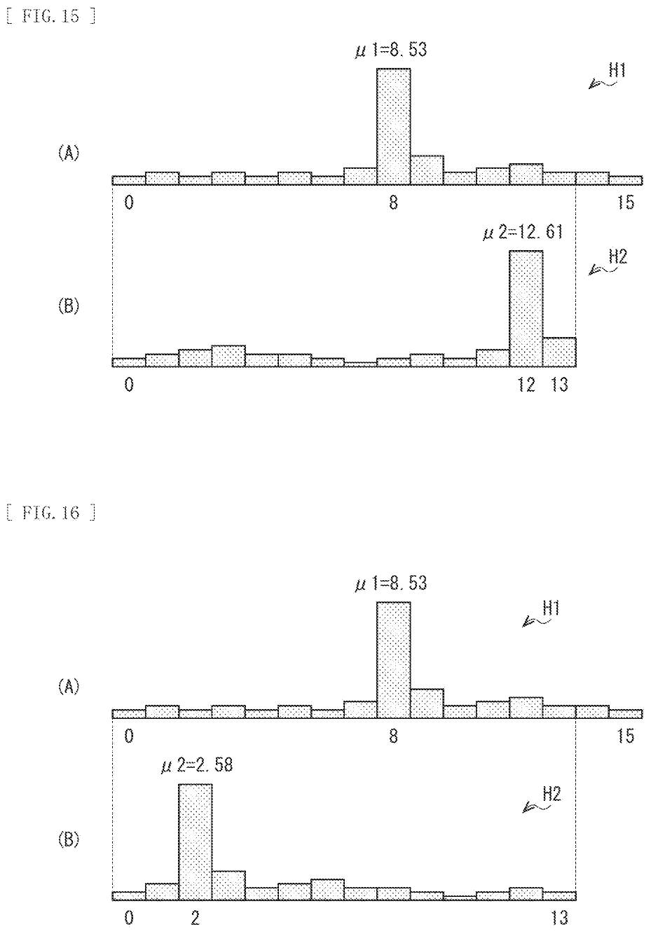

FIGS. 13 and 14 illustrate an example of a method of calculating the peak centroid value μ1.

First, the distance arithmetic section 16 performs a padding process on the basis of the histogram H1 (step S111). Specifically, as illustrated in (A) and (B) of FIG. 14, the distance arithmetic section 16 copies four frequency values of four bins including 0th to 3rd bins in the histogram H1 to the right side of the histogram H1, and copies four frequency values of four bins including 12th to 15th bins in the histogram H1 to the left side of the histogram H1. A histogram generated in such a way includes 24 bins. This makes it possible to reduce a possibility that accuracy of a centroid position is degraded in a case where the histogram H1 has its peak position at its side end, for example.

Next, the distance arithmetic section 16 calculates a floor component of the histogram (step S112). Specifically, for example, the distance arithmetic section 16 segments 24 bins in the histogram illustrated in (B) of FIG. 14 into six units by using four bins as one unit. Next, the distance arithmetic section 16 calculates a sum value of four frequency values with regard to each of the six units. Next, the distance arithmetic section 16 specifies two sum values having a smallest difference therebetween, among 86 sum values with regard to the six units. Next, the distance arithmetic section 16 calculates the floor component by calculating an average value of eight frequency values of the two units relevant to two sum values ((C) of FIG. 14). The floor component is indicated by a dashed line in (C) of FIG. 14.

Next, the distance arithmetic section 16 subtracts the floor component from each of the frequency values of the histogram (step S113). Specifically, for example, the distance arithmetic section 16 subtracts the floor component indicated by the dashed line in (C) of FIG. 14 from the histogram illustrated in (C) of FIG. 14 ((D) of FIG. 14).

Next, the distance arithmetic section 16 detects a peak bin in the histogram (step S114), and calculates the peak centroid value μ1 (step S115). Specifically, as illustrated in (E) of FIG. 14, the distance arithmetic section 16 sets three bins including the peak bin as a centroid calculation range Rcal in this example. For example, a width of the centroid calculation range Rcal is set in accordance with the pulse width of the light pulse L0. In this example, as illustrated in FIG. 10, the pulse width of the light pulse L0 is similar to the bin width of the histogram H1. Thus, the three bins are set as the centroid calculation range Rcal. For example, four or more bins may be set as the centroid calculation range Rcal in a case where the light pulse L0 has a pulse width that is wider than the bin width of the histogram H1. Thereafter, the distance arithmetic section 16 calculates the peak centroid value μ1 in the centroid calculation range Rcal by using the following expression, for example.

$$μ1 = \sum ( Cbin [ i ] \times ( i + 0.5 ) ) / \sum Cbin [ i ]$$

where Cbin[i] represents a frequency value of an i-th bin of a histogram. “0.5” is a value for setting the frequency value Cbin[i] as a center value in a bin width direction and for preventing missing of information when i=0.

In such a way, the distance arithmetic section 16 calculates the peak centroid value μ1 on the basis of the histogram H1.

Next, as illustrated in FIG. 12, on the basis of the histogram H2, the distance arithmetic section 16 calculates a peak centroid value μ2 indicating a peak position of the histogram H2 (step S102). A method of calculating the peak centroid value μ2 is similar to the method of calculating the peak centroid value μ1 illustrated in FIGS. 13 and 14.

Next, the distance arithmetic section 16 checks whether the peak centroid values μ1 and μ2 satisfy the following relational expression (step S103).

$$μ 2 - μ 1 + ε > 0$$

where ε is expressible by the following expression.

$$ε = \vert n 1 - n 2 \vert / 2$$

where n1 represents a parameter indicating the number of bins in the histogram H1, and n2 represents a parameter indicating the number of bins in the histogram H2.

In a case where the relational expression is satisfied in step S103 (“Y” in step S103), the distance arithmetic section 16 calculates a peak shift value θ by using the following expression (step S104).

$$θ = μ 2 - μ 1$$

Alternatively, in a case where the relational expression is not satisfied in step S103 (“N” in step S103), the distance arithmetic section 16 calculates the peak shift value θ by using the following expression (step S105).

$$θ = µ2 - µ1 + n 2$$

Next, the distance arithmetic section 16 calculates an offset ρ by using the following expression (step S106).

$$ρ = int ( θ / \vert n 1 - n 2 \vert ) \times n 1$$

where int represents a function for obtaining an integer of an argument.

Next, the distance arithmetic section 16 calculates a distance value D by using the following expression (step S107).

$$D = ( µ1 + ρ ) \times Δ D$$

where ΔD represents a parameter for converting the bin width into the distance value, and “μ1+ρ” corresponds to the detection timing of the reflected light pulse L1 in the macropixel MP. The detection timing is a value obtained in units of the bin width. This allows the distance arithmetic section 16 to calculate the distance value D by using the above expression.

The process thus ends.

In the following, the process performed by the distance arithmetic section 16 illustrated in FIG. 12 will be specifically described with reference to some examples.

FIG. 15 illustrates an example of the histograms H1 and H2 obtained by the photodetection system 1. First, the distance arithmetic section 16 calculates the peak centroid value μ1 on the basis of the histogram H1 and calculates the peak centroid value μ2 on the basis of the histogram H2 (steps S101 and S102). In this example, the peak centroid value μ1 is “8.53”, and the peak centroid value μ2 is “12.61”.

Next, the distance arithmetic section 16 checks whether the peak centroid values μ1 and μ2 satisfy the relational expression in step S103 (step S103). In this example, the number n1 of bins in the histogram H1 is “16”, and the number n2 of bins in the histogram H2 is “14”. Therefore, the parameter ε is “1”. Accordingly, the distance arithmetic section 16 calculates “μ2−μ1+ε” as follows.

$$µ2 - µ1 + ε = 12.61 - 8.53 + 1 = 5.08$$

Therefore, in this example, the relational expression in step S103 is satisfied. The distance arithmetic section 16 calculates the peak shift value θ as follows (step S104).

$$θ = 12.61 - 8.53 = 4.08$$

Next, the distance arithmetic section 16 calculates the offset ρ as follows (step S106).

$$ρ = int ( 4.08 / 2 ) \times 16 = 32$$

Next, the distance arithmetic section 16 calculates the distance value D as follows (step S107).

$$D = ( 8.53 + 32 ) \times 0.06 = 2.43 [ m ]$$

FIG. 16 illustrates another example of the histograms H1 and H2 obtained by the photodetection system 1. First, the distance arithmetic section 16 calculates the peak centroid value μ1 on the basis of the histogram H1 and calculates the peak centroid value μ2 on the basis of the histogram H2 (steps S101 and S102). In this example, the peak centroid value μ1 is “8.53”, and the peak centroid value μ2 is “2.58”.

Next, the distance arithmetic section 16 checks whether the peak centroid values μ1 and μ2 satisfy the relational expression in step S103 (step S103). The distance arithmetic section 16 calculates “μ2−μ1+ε” as follows.

$$µ2 - µ1 + ε = 2.58 - 8.53 + 1 = - 4.95$$

Therefore, in this example, the relational expression in step S103 is not satisfied. The distance arithmetic section 16 calculates the peak shift value θ as follows (step S105).

$$θ = 2.58 - 8.53 + 14 = 8.05$$

Next, the distance arithmetic section 16 calculates the offset ρ as follows (step S106).

$$ρ = int ( 8.05 / 2 ) \times 16 = 64$$

Next, the distance arithmetic section 16 calculates the distance value D as follows (step S107).

$$D = ( 8.53 + 64 ) \times 0.06 = 4.35 [ m ]$$

In such a way, the distance arithmetic section 16 calculates the distance value D on the basis of the histograms H1 and H2.

As described above, in the photodetection section 1, the TDC section 22 generates the first code (the counter code TDCCODE1) that sequentially changes over time during the first period (the period T1) having a first time length in the frame period F and that circulates multiple times in units of the first period (the period T1), and generates the second code (the counter code TDCCODE2) that sequentially changes over time during the second period (the period T2) having a second time length different from the first time length in the frame period F and that circulates multiple times in units of the second period. The TDC section 22 generates the first timing code (the timing code CODE1) by sampling the first code (the counter code TDCCODE1) in accordance with the detection timing of the reflected light pulse L1, and generates the second timing code (the timing code CODE2) by sampling the second code (the counter code TDCCODE2) in accordance with the detection timing. The histogram generation section 23 generates the first histogram (the histogram H1) related to the first timing code (the timing code CODE1) and generates the second histogram (the histogram H2) related to the second timing code (the timing code CODE2). This makes it possible for the photodetection system 1 to reduce its circuit area, as described below.

In other words, for example, the photodetection system 1 widens the distance measurement range while increasing temporal resolution, by using the two counter codes TDCCODE1 and TDCCODE2 as illustrated in FIG. 8. In other words, the photodetection system 1 is able to perform the distance measurement operation on the basis of the detection timing of the reflected light pulse 1 that enters in the period from the timing t21 to the timing t28. Supposing the counter code TDCCODE2 is not used and only the counter code TDCCODE1 is used, the photodetection system is unable to make a distinction between the detection timing of the reflected light pulse L1 that enters in the period from the timing t21 to the timing t22 and the detection timing of the reflected light pulse L1 that enters in, for example, the period from the timing t22 to the timing t23. Thus, the photodetection system is to perform the distance measurement operation on the basis of the detection timing of the reflected light pulse 1 that enters in the period from the timing t21 to the timing t22. This results in a narrower distance measurement range. In this case, to widen the distance measurement range while increasing the temporal resolution, it is necessary to increase a maximum count value of the counter 32 and increase the number of AND circuits and the number of counters in the histogram generation circuit 34, for example. In this case, the circuit size increases, and the circuit area also increases accordingly.

In contrast, the photodetection system 1 uses the two counter codes TDCCODE1 and TDCCODE2 as illustrated in FIG. 8. This makes it possible for the photodetection system 1 to make a distinction between the detection timing of the reflected light pulse L1 that enters in the period from the timing t21 to the timing t22 and the detection timing of the reflected light pulse L1 that enters in, for example, the period from the timing t22 to the timing t23. Accordingly, it is possible for the photodetection system 1 to reduce its circuit size, and this makes it possible to reduce its circuit area.

In addition, in the photodetection system 1, as illustrated in FIGS. 8 and 9, the number of values that the first code (the counter code TDCCODE1) can take during the first period (the period T1) is made different from the number of values that the second code (the counter code TDCCODE2) can take during the second period (the period T2). This makes it possible to generate the counter code TDCCODE1 and the counter code TDCCODE2 on the basis of the clock signal CLK generated by the single clock signal generator 31, for example. It is thus possible to simplify the circuit configuration.

### Effects

As described above, in the present embodiment, the TDC section generates: the first code that sequentially changes over time during the first period having the first time length in the frame period and that circulates multiple times in units of the first period; and the second code that sequentially changes over time during the second period having the second time length different from the first time length in the frame period and that circulates multiple times in units of the second period. The TDC section generates the first timing code by sampling the first code in accordance with the detection timing of the reflected light pulse, and generates the second timing code by sampling the second code in accordance with the detection timing. The histogram generation section generates the first histogram related to the first timing code and generates the second histogram related to the second timing code. This makes it possible to reduce the circuit area.

In the present embodiment, the number of values that the first code can take during the first period is made different from the number of values that the second code can take during the second period. This makes it possible to simplify the circuit configuration.

### Modification Example 1-1

In the above-described embodiment, the counter 32 performs the counting operation during the sub-frame period SF1 in such a manner that the counter code TDCCODE1 has a value that circulates in the range of “0” or more and “15” or less, and the counter 32 performs the counting operation during the sub-frame period SF2 in such a manner that the counter code TDCCODE2 has a value that circulates in the range of “0” or more and “13” or less. However, this is not limitative. In the following, the present modification example will be described with reference to several examples.

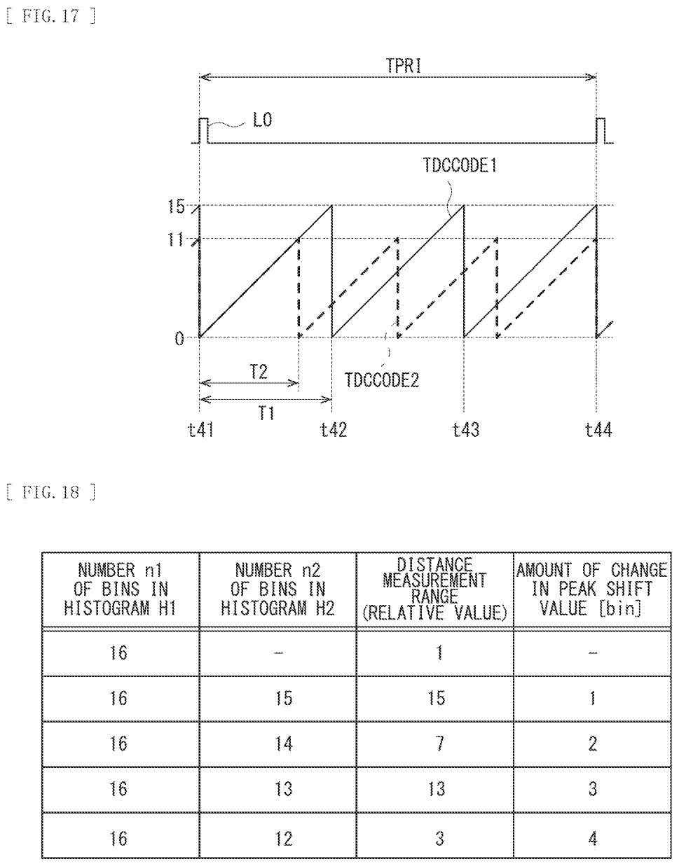

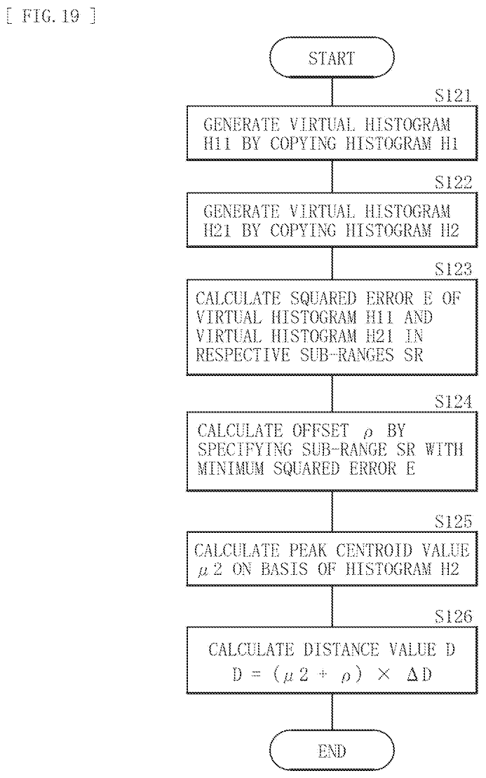

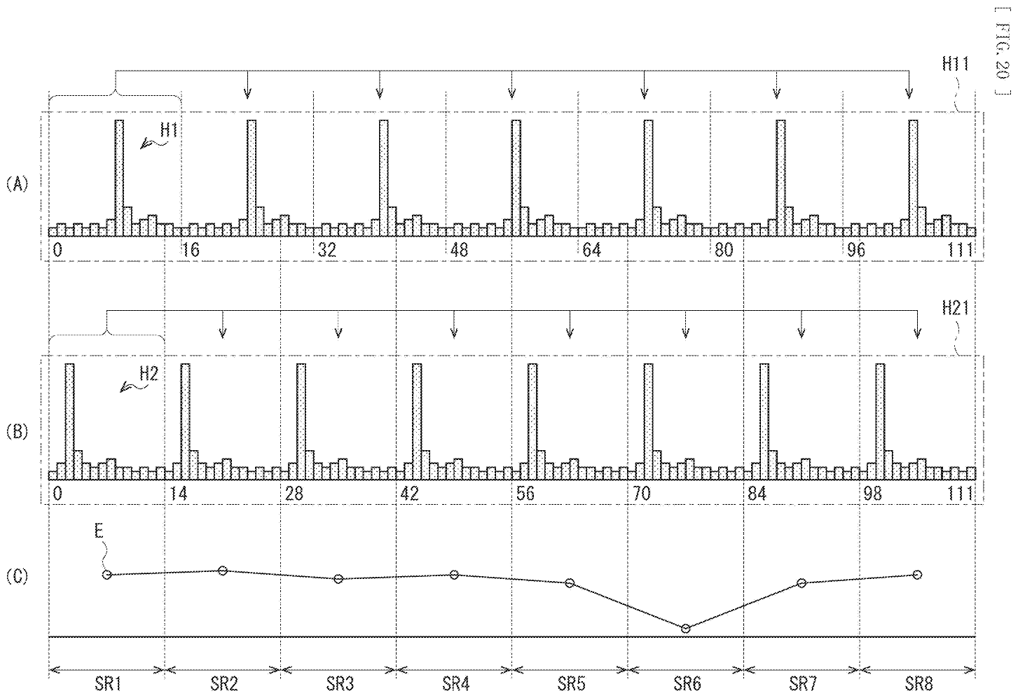

FIG. 17 illustrates an operation example of the photodetection system 1 according to the present modification example. In this example, the counter 32 performs a counting operation during the sub-frame period SF1 in such a manner that the counter code TDCCODE1 has a value that circulates in the range of “0” or more and “15” or less, and the counter 32 performs the counting operation during the sub-frame period SF2 in such a manner that the counter code TDCCODE2 has a value that circulates in the range of “0” or more and “11” or less. The counter code TDCCODE1 circulates three times during the unit exposure period TPRI. The counter code TDCCODE2 circulates four times during the unit exposure period TPRI.

In this case, for example, in a case where the reflected light pulse L1 enters the photodiode PD in a period from a timing t41 to a timing t42, the peak position of the histogram H2 is almost same as the peak position of the histogram H1. In other words, the amount of difference between the peak positions (the peak shift value) is almost “0”.

In contrast, for example, in a case where the reflected light pulse L1 enters the photodiode PD in a period from the timing t42 to a timing t43, the peak position of the histogram H2 is shifted from the peak position of the histogram H1 to the right by about four bins. In other words, the peak shift value is about “4” in units of bin width.

In such a manner, the peak shift value changes by “4” depending on the period in which the reflected light pulse L1 enters. The amount of change in the peak shift value corresponds to a difference between the number of bins in the histogram H1 (“16” in this example) and the number of bins in the histogram H2 (“12” in this example). The distance arithmetic section 16 determines such a peak shift value and this makes it possible for the distance arithmetic section 16 to determine which of the period from the timing t41 to the timing t42, the period from the timing t42 to the timing t43, and the period from the timing t43 to the timing t24 the reflected light pulse L1 has entered the photodiode PD in. In other words, the distance arithmetic section 16 is able to distinguish among three distance ranges by determining such peak shift values. This makes it possible for the photodetection system 1 to widen the distance measurement range to threefold that in the case of using only the counter code TDCCODE1 without using the counter code TDCCODE2. In addition, it is easier to distinguish among the distance ranges because it is possible to set the amount of change in the peak shift value to “4”.

FIG. 18 illustrates the distance measurement ranges and the amounts of change in the peak shift value in a case where the number n1 of bins in the histogram H1 and the number n2 of bins in the histogram H2 are set to various values. The distance measurement range is presented in relative values such that the distance measurement range has a value of “1” in a case where only the counter code TDCCODE1 is used and the counter code TDCCODE2 is not used.

The register 25 of the control section 24 allows for storing of the number n1 of bins in the histogram H1 and the number n2 of bins in the histogram H2, for example. This makes it possible for the photodetection system 1 to perform the distance measurement operation on the basis of various settings as described above.

It is to be noted that although the number n1 of bins in the histogram H1 is larger than the number n2 of bins in the histogram H2 in this example, this is not limitative. Alternatively, for example, the number n2 of bins in the histogram H2 may be larger than the number n1 of bins in the histogram H1.

### Modification Example 1-2

In the above-described embodiment, the distance arithmetic section 16 calculates the distance value D on the basis of the histograms H1 and H2 by using the method illustrated in FIG. 12. However, this is not limitative, and various methods are usable. A description will be given below with reference to an example.

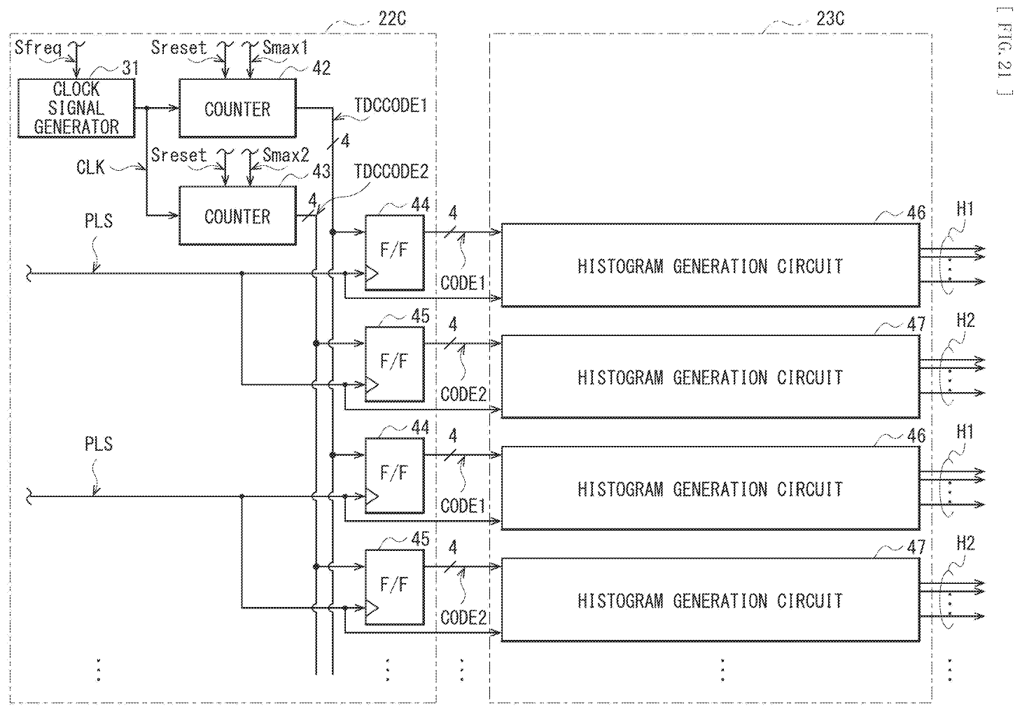

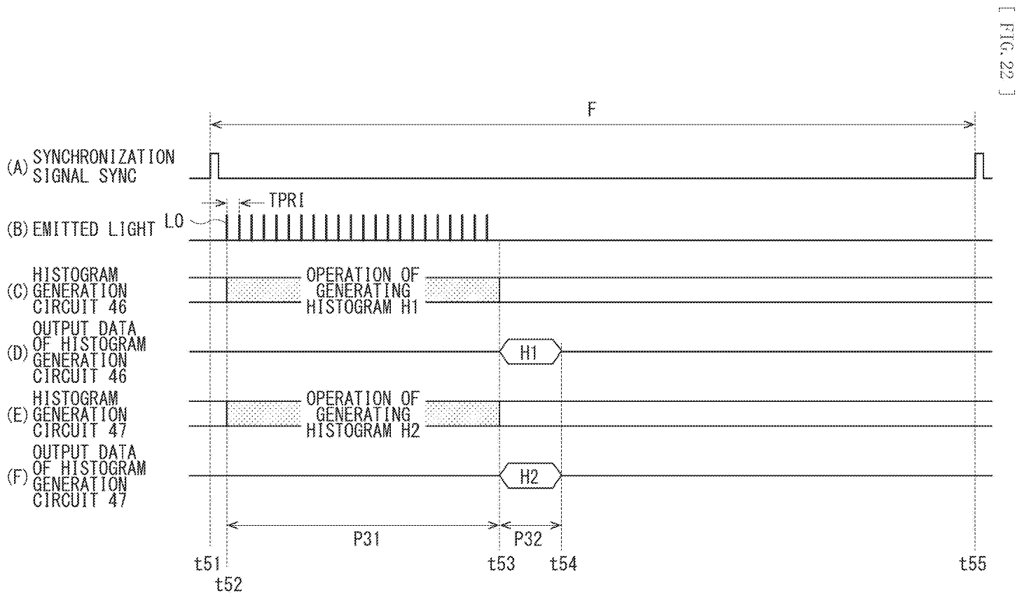

FIGS. 19 and 20 illustrate an operation example of the distance arithmetic section 16 according to the present modification example.

First, the distance arithmetic section 16 generates a virtual histogram H11 by copying the histogram H1 (step S121). Specifically, as illustrated in (A) of FIG. 20, the distance arithmetic section 16 generates the virtual histogram H11 by copying the histogram H1 six times and putting them together. The virtual histogram H11 includes a histogram including 16th to 31st bins, a histogram including 32nd to 47th bins, a histogram including 48th to 63rd bins, a histogram including 64th to 79th bins, a histogram including 80th to 95th bins, and a histogram including 96th to 111st bins, and each of the histograms is the same as the histogram H1. The number of bins in the histogram H1 is “16”, and therefore the number of bins in the virtual histogram H11 is “112”.

Next, the distance arithmetic section 16 generates a virtual histogram H21 by copying the histogram H2 (step S122). Specifically, as illustrated in (B) of FIG. 20, the distance arithmetic section 16 generates the virtual histogram H21 by copying the histogram H2 seven times and putting them together. The virtual histogram H21 includes a histogram including 14th to 27th bins, a histogram including 28th to 41st bins, a histogram including 42nd to 55th bins, a histogram including 56th to 69th bins, a histogram including 70th to 83rd bins, a histogram including 84th to 97th bins, and a histogram including 98th to 111st bins, and each of the histograms is the same as the histogram H2. The number of bins in the histogram H2 is “14”, and therefore the number of bins in the virtual histogram H21 is “112”.

As illustrated in (A) and (B) of FIG. 20, the number of bins in the virtual histogram H11 and the number of bins in the virtual histogram H21 are equal to each other. The number of bins in the virtual histograms H11 and H21 (“112” in this example) is a least common multiple of the number of bins in the histogram H1 (“16” in this example) and the number of bins in the histogram H2 (“14” in this example).

Next, the distance arithmetic section 16 calculates a squared error E of the virtual histogram H11 and the virtual histogram H21 in each of a plurality of sub-ranges SR set in accordance with the virtual histogram H21 (step S123). In this example, as illustrated in FIG. 20, on the basis of the virtual histogram H21, a range from a 1st bin to a 13th bin is defined as a sub-range SR1, a range from the 14th bin to the 27th bin is defined as a sub-range SR2, a range from the 28th bin to the 41st bin is defined as a sub-range SR3, a range from the 42nd bin to the 55th bin is defined as a sub-range SR4, a range from the 56th bin to the 69th bin is defined as a sub-range SR5, a range from the 70th bin to the 83rd bin is defined as a sub-range SR6, a range from the 84th bin to the 97th bin is defined as a sub-range SR7, and a range from the 98th bin to the 111st bin is defined as a sub-range SR8. The distance arithmetic section 16 calculates the squared error E of the virtual histograms H11 and H21 in each of the eight sub-ranges SR1 to SR8. The distance arithmetic section 16 calculates the squared error E of the virtual histograms H11 and H21 in each of the sub-ranges SR1 to SR8 by using the following expression, for example.

$$E = Σ ( ( Cbin 1 [ i ] - Cbin 2 [ i ] ) \hat{} 2 )$$

where Cbin[i] represents a frequency value of an i-th bin in a sub-range SR of interest in the virtual histogram H11, and Cbin2[i] represents a frequency value of the i-th bin in the sub-range SR of interest in the virtual histogram H21.

For example, referring to the example of FIG. 20, in the sub-range SR1, the virtual histogram H11 and the virtual histogram H21 are greatly different from each other, and therefore the squared error of the virtual histograms H11 and H21 is of a large value. In addition, for example, in the sub-range SR6, a peak position of the virtual histogram H11 and a peak position of the virtual histogram H21 are the same, and therefore the virtual histogram H11 and the virtual histogram H21 have a high degree of similarity. Therefore, the squared error E of the virtual histograms H11 and H21 is of a small value.

Next, the distance arithmetic section 16 calculates the offset ρ by specifying a sub-range SR with a minimum squared error E (step S124). Specifically, the distance arithmetic section 16 takes, as the offset ρ, the number of a leftmost bin in the sub-range SR with the minimum squared error E. In the example of FIG. 20, the minimum squared error E is obtained in the sub-range SR6. The distance arithmetic section 16 therefore takes “70”, which is the number of the leftmost bin in the sub-range SR6, as the offset ρ.

Next, on the basis of the histogram H2, the distance arithmetic section 16 calculates a peak centroid value μ2 indicating a peak position of the histogram H2 (step S125). A method of calculating the peak centroid value μ2 is similar to the method of calculating the peak centroid value μ1 according to the above-described embodiment (FIGS. 13 and 14).

Next, the distance arithmetic section 16 calculates a distance value D by using the following expression (step S126).

$$D = ( µ2 + ρ ) \times Δ D$$

The process thus ends.

As described above, in the present modification example, the arithmetic circuit 16 calculates the detection timing of the reflected light pulse L1 by calculating the degree of similarity between the first histogram and the second histogram while changing a relative positional relationship between the histogram H1 and the histogram H2. This also makes it possible to achieve effects similar to those of the above-described embodiment.

### Modification Example 1-3

In the above-described embodiment, the sub-frame periods SF1 and SF2 are set, the histogram H1 is generated in the sub-frame period SF1, and the histogram H2 is generated in the sub-frame period SF2; however, this is not limitative. Alternatively, for example, it is also possible to simultaneously generate the histograms H1 and H2 without setting the sub-frame period SF1 or SF2. In the following, a detailed description will be given of a TDC section 22C and a histogram generation section 23C according to the present modification example.

FIG. 21 illustrates a configuration example of the TDC section 22C and the histogram generation section 23C.

The TDC section 22C includes the clock signal generator 31, counters 42 and 43, a plurality of flip-flops 44, and a plurality of flip-flops 45.

The counter 42 is configured to generate the counter code TDCCODE1 by performing the counting operation on the basis of the clock signal CLK. The counter 42 resets the counter code TDCCODE1 on the basis of the control signal Sreset supplied from the control section 24 (FIG. 3). In addition, the counter 42 is configured to set a maximum value of the counter code TDCCODE1 on the basis of a control signal Smax1 supplied from the control section 24. The counter 42 thus performs the counting operation in such a manner that the counter code TDCCODE1 has a value that circulates in a range from “0” to the maximum value indicated by the control signal Smax1.

The counter 43 is configured to generate the counter code TDCCODE2 by performing the counting operation on the basis of the clock signal CLK. The counter 43 resets the counter code TDCCODE2 on the basis of the control signal Sreset supplied from the control section 24 (FIG. 3). In addition, the counter 43 is configured to set a maximum value of the counter code TDCCODE2 on the basis of a control signal Smax2 supplied from the control section 24. The counter 43 thus performs the counting operation in such a manner that the counter code TDCCODE2 has a value that circulates in a range from “0” to the maximum value indicated by the control signal Smax2.

The pulse signal PLS generated by the macropixel MP is supplied to the flip-flops 44 and the flip-flops 45.

Each of the plurality of flip-flops 44 is configured to generate the timing code CODE1 of multiple bits by sampling the counter code TDCCODE1 of multiple bits on the basis of a rising edge of the pulse signal PLS.

Each of the plurality of flip-flops 45 is configured to generate the timing code CODE2 of multiple bits by sampling the counter code TDCCODE2 of multiple bits on the basis of the rising edge of the pulse signal PLS.

The histogram generation section 23C includes a plurality of histogram generation circuits 46 and a plurality of histogram generation circuits 47.

Each of the plurality of histogram generation circuits 46 is configured to generate, on the basis of the timing code CODE1 and the pulse signal PLS relevant to a single macropixel MP, the histogram H1 related to the timing code CODE1 relevant to the macropixel MP. The histogram generation circuits 46 each have a circuit configuration similar to the circuit configuration of the histogram generation circuit 34 (FIG. 6) according to the above-described embodiment.

Each of the plurality of histogram generation circuits 47 is configured to generate, on the basis of the timing code CODE2 and the pulse signal PLS relevant to a single macropixel MP, the histogram H2 related to the timing code CODE2 relevant to the macropixel MP. The histogram generation circuits 47 each have a circuit configuration similar to the circuit configuration of the histogram generation circuit 34 (FIG. 6) according to the above-described embodiment.

FIG. 22 illustrates an operation example of the photodetection system 1 according to the present modification example. (A) of FIG. 22 illustrates the waveform of the synchronization signal SYNC. (B) of FIG. 22 illustrates the waveform of light emitted from the light-emitting section 12. (C) of FIG. 22 illustrates operation of the histogram generation circuit 46. (D) of FIG. 22 illustrates output data of the histogram generation circuit 46. (E) of FIG. 22 illustrates operation of the histogram generation circuit 47. (F) of FIG. 22 illustrates output data of the histogram generation circuit 48.

A frame period F is started by a pulse of the synchronization signal SYNC at a timing t51 ((A) of FIG. 22). The control section 24 uses the control signal Smax1 to instruct the counter 42 of the TDC section 22C to perform the counting operation in the range of “0” or more and “15” or less. In addition, the control section 24 uses the control signal Smax2 to instruct the counter 43 of the TDC section 22C to perform the counting operation in the range of “0” or more and “13” or less.

Next, during a period from a timing t52 to a timing t53 (an exposure period P31), the light-emitting section 12 repeatedly emits the light pulse L0 in a predetermined cycle in units of the unit exposure period TPRI ((B) of FIG. 22). The reflected light pulse L1 based on the light pulse L0 repeatedly enters the photodetection system 1. The macropixel MP generates the pulse signal PLS by detecting the reflected light pulses L1. The pulse signal PLS includes a plurality of pulses generated each time the macropixel MP detects the reflected light pulse L1.

The counter 42 of the TDC section 22C performs the counting operation in such a manner that the counter code TDCCODE1 has a value that circulates in the range of “0” or more and “15” or less. The flip-flop 44 repeatedly generates the timing code CODE1 corresponding to the detection timing of the reflected light pulse L1 in the macropixel MP by sampling the counter code TDCCODE1 on the basis of the pulse signal PLS. During the exposure period P31, the histogram generation circuit 46 of the histogram generation section 23C generates the histogram H1 on the basis of the plurality of timing codes CODE1 ((C) of FIG. 22).

In a similar way, the counter 43 of the TDC section 22C performs the counting operation in such a manner that the counter code TDCCODE2 has a value that circulates in the range of “0” or more and “13” or less. The flip-flop 45 repeatedly generates the timing code CODE2 corresponding to the detection timing of the reflected light pulse L1 in the macropixel MP by sampling the counter code TDCCODE2 on the basis of the pulse signal PLS. During the exposure period P31, the histogram generation circuit 47 of the histogram generation section 23C generates the histogram H2 on the basis of the plurality of timing codes CODE2 ((E) of FIG. 22).

Next, during a period from the timing t53 and a timing t54 (an output period P32), the histogram generation circuit 46 outputs the generated histogram H1 to the distance arithmetic section 16 ((D) of FIG. 22), and the histogram generation circuit 47 outputs the generated histogram H2 to the distance arithmetic section 16 ((F) of FIG. 22)

Subsequently, at a timing t55, the frame period F ends and a new frame period F starts. The photodetection system 1 repeats the operations performed from the timing t51 to the timing t55 at a predetermined frame rate.

For example, the operations of the counters 42 and 43 performed during the unit exposure period TPRI are similar to those in the above-described first embodiment (FIG. 9). In addition, for example, the operation of the distance arithmetic section 16 is also similar to that in the above-described first embodiment (FIGS. 12 to 16).

Here, the exposure period P31 corresponds to a specific example of the “exposure period” according to the present disclosure. The unit exposure period TPRI in the exposure period P31 corresponds to a specific example of the “unit exposure period” according to the present disclosure. [Other Modification Examples]

Moreover, two or more of the above-described modification examples may be applied in combination.

### 2. Second Embodiment

Next, a description will be given of a photodetection system 2 according to a second embodiment. In the present embodiment, a method of causing the time length of the period T1 and the time length of the period T2 to be different from each other is different from that in the above-described first embodiment. In other words, in the above-described first embodiment, the time length of the period T1 and the time length of the period T2 are caused to be different from each other by causing the maximum value of the counter code TDCCODE 1 and the maximum value of the counter code TDCCODE2 to be different from each other; whereas in the present embodiment, the time length of the period T1 and the time length of the period T2 are caused to be different from each other by causing an update cycle of the counter code TDCCODE 1 and an update cycle of the counter code TDCCODE2 to be different from each other. It is to be noted that structural elements that are substantially the same as the structural elements included in the photodetection system 1 according to the above-described first embodiment will be denoted with the same reference signs as those in the first embodiment, and repeated description will be omitted.

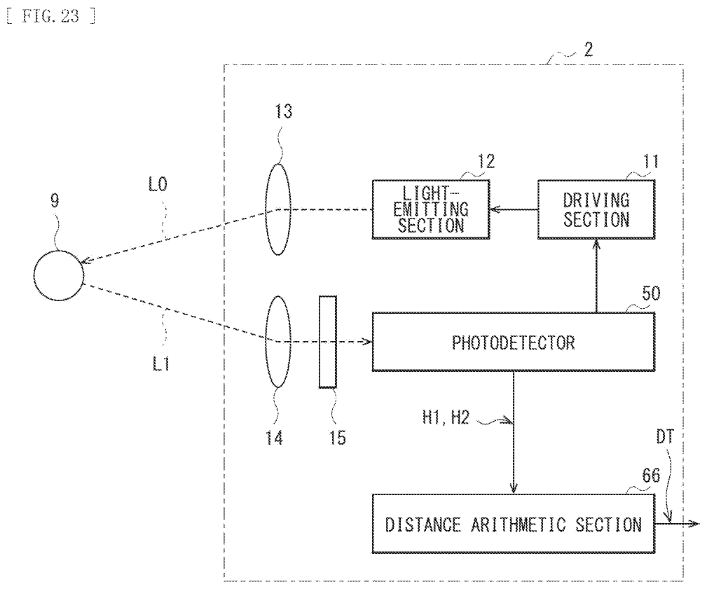

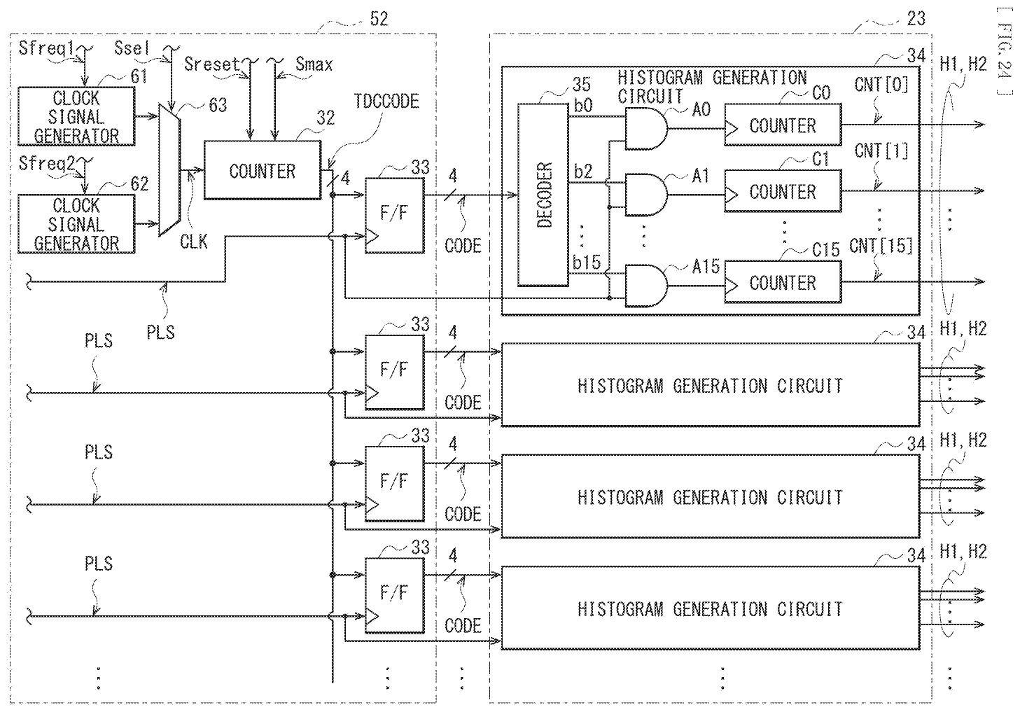

FIG. 23 illustrates a configuration example of the photodetection system 2 according to the second embodiment. The photodetection system 2 includes a photodetector 50 and a distance arithmetic section 66.

As with the photodetector 20 (FIG. 3) according to the first embodiment, the photodetector 50 includes the pixel array 21, a TDC section 52, the histogram generation section 23, and the control section 24.

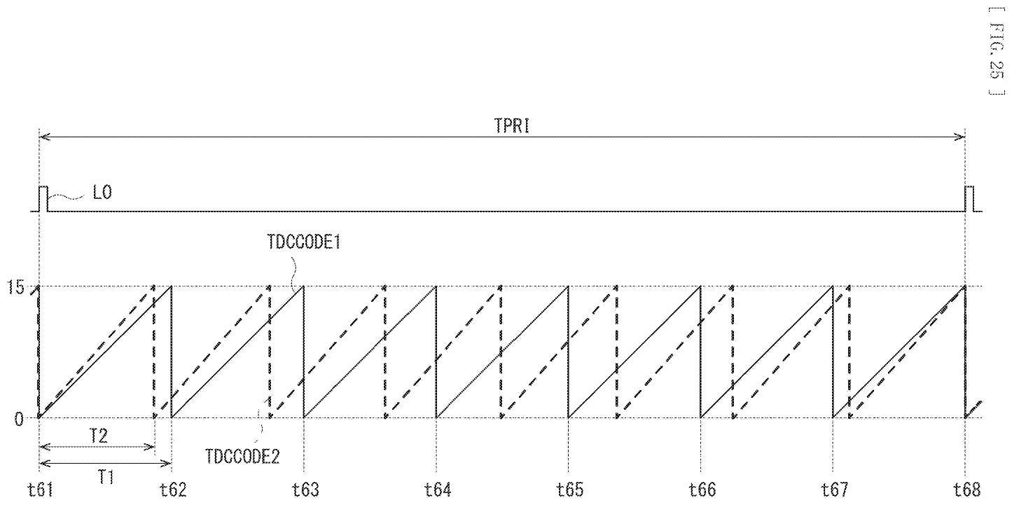

FIG. 24 illustrates a configuration example of the TDC section 52 and the histogram generation section 23. The TDC section 52 includes clock signal generators 61 and 62 and a selector 63.

The clock signal generator 61 is configured to generate a clock signal. The clock signal generator 61 is able to change the frequency of the clock signal on the basis of a control signal Sfreq1 supplied from the control section 24. In this example, the clock signal generator 61 generates a clock signal of 2.5 GHz on the basis of the control signal Sfreq1.

The clock signal generator 62 is configured to generate a clock signal. The clock signal generator 62 is able to change the frequency of the clock signal on the basis of a control signal Sfreq2 supplied from the control section 24. In this example, the clock signal generator 61 generates a clock signal of 2.86 GHz on the basis of the control signal Sfreq2.

The selector 63 is configured to, on the basis of a control signal Ssel supplied from the control section 24, select one of the control signal generated by the clock signal generator 61 and the clock signal generated by the clock signal generator 62 and output the selected clock signal as the clock signal CLK. The clock signal CLK is supplied to the counter 32.

As with the distance arithmetic section 16 (FIG. 1) according to the first embodiment, the distance arithmetic section 66 (FIG. 23) is configured to calculate a distance value of a distance between the photodetection system 2 and the measurement target 9 on the basis of the histograms H1 and H2 related to the macropixel MP. In addition, the distance arithmetic section 66 generates distance data DT including data of respective distance values of the plurality of macropixels MP.

The sub-frame periods SF1 and SF2 are set for the photodetection system 2 as in the case of the photodetection system 2 (FIG. 7) according to the first embodiment. In this example, the clock signal generator 61 generates the clock signal of 2.5 GHZ, and the clock signal generator 62 generates the clock signal of 2.86 GHz. During the sub-frame period SF1, the control section 24 uses the control signal Ssel to instruct the selector 63 of the TDC section 52 to output the clock signal generated by the clock signal generator 61 as the clock signal CLK. In addition, during the sub-frame period SF2, the control section 24 uses the control signal Ssel to instruct the selector 63 of the TDC section 52 to output the clock signal generated by the clock signal generator 62 as the clock signal CLK. The counter 32 of the TDC section 52 performs the counting operation in such a manner that the counter codes TDCCODE and TDCCODE2 have respective values that circulate in the range of “0” or more and “15” or less during the sub-frame periods SF1 and SF2.

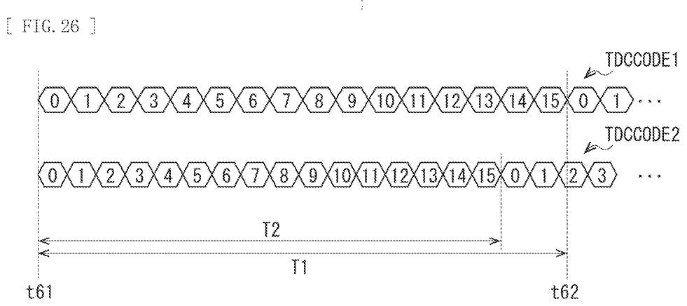

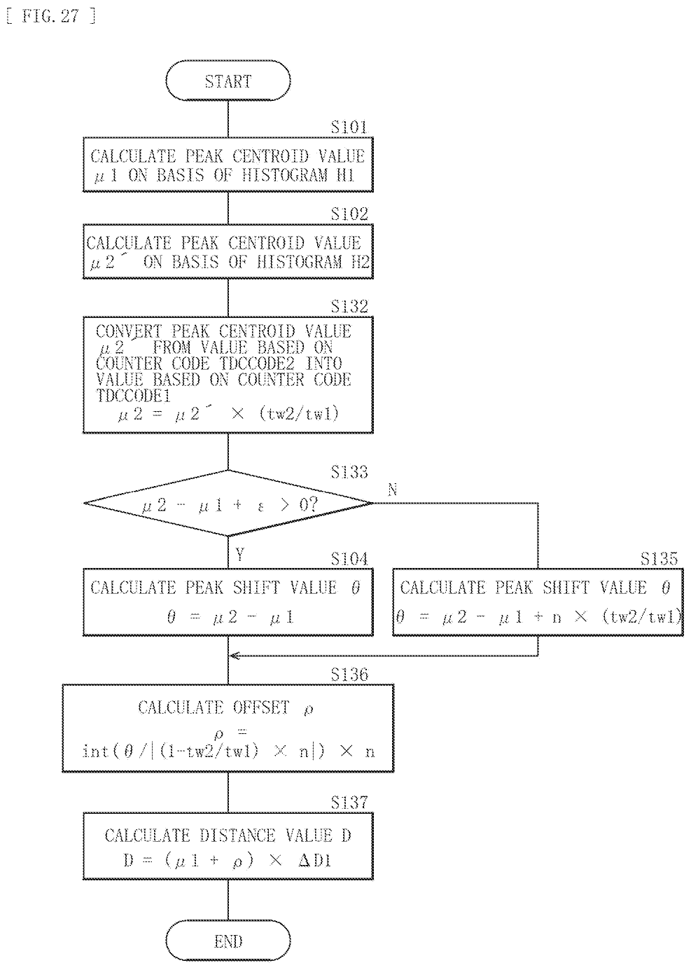

FIGS. 25 and 26 illustrate an operation example of the counter 32 in the unit exposure period TPRI. As illustrated in FIG. 25, the sub-frame period SF1 and the sub-frame period SF2 are different from each other; however, FIGS. 25 and 26 illustrate the counter codes TDCCODE1 and TDCCODE2 in an overlapping manner within the same time scale. In this example, the counter codes TDCCODE1 and TDCCODE2 circulate in the range of “0” or more and “15” or less.

During the sub-frame period SF1, the counter 32 generates the counter code TDCCODE1 on the basis of the clock signal of 2.5 GHz generated by the clock signal generator 61. Therefore, the counter code TDCCODE1 has an update cycle of 400 psec. (=1/2.5 GHZ) in this example. In other words, the temporal resolution is 400 psec. during the sub-frame period SF1.

During the sub-frame period SF2, the counter 32 generates the counter code TDCCODE2 on the basis of the clock signal of 2.86 GHz generated by the clock signal generator 62. Therefore, the counter code TDCCODE2 has an update cycle of 350 psec. (=1/2.86 GHz) in this example. In other words, the temporal resolution is 350 psec. during the sub-frame period SF2. The temporal resolution during the sub-frame period SF2 is 7/8 times the temporal resolution during the sub-frame period SF1.

The counter code TDCCODE1 sequentially changes from “0” to “15” during each of a plurality of periods T1 in the sub-frame period SF1. Specifically, the counter code TDCCODE1 sequentially changes from “0” to “15” during each of a period from a timing t61 to a timing t62, a period from the timing t62 to a timing t63, a period from the timing t63 to a timing t64, a period from the timing t64 to a timing t65, a period from the timing t65 to a timing t66, a period from the timing t66 to a timing t67, and a period from the timing t67 to a timing t68. The counter code TDCCODE1 can take any of the values of “0” or more and “15” or less. Therefore, the number of possible values of the counter code TDCCODE1 is 16. The counter code TDCCODE1 circulates seven times during the unit exposure period TPRI.

In addition, the counter code TDCCODE2 sequentially changes from “0” to “15” during each of a plurality of periods T2 in the sub-frame period SF2. The counter code TDCCODE2 can take any of the values of “0” or more and “15” or less. Therefore, the number of possible values of the counter code TDCCODE2 is 16. The counter code TDCCODE2 circulates eight times during the unit exposure period TPRI.

As illustrated in FIGS. 25 and 26, the length of the period T1 as the unit of circulation of the counter code TDCCODE1 and the length of the period T2 as the unit of circulation of the counter code TDCCODE2 are different from each other. Therefore, the relationship between the peak position in the histogram H1 and the peak position in the histogram H2 changes depending on which of periods within a period from the timing t61 to the timing t68 the reflected light pulse L1 enters the photodiode PD in.

By determining the relationship between the peak position in the histogram H1 and the peak position in the histogram H2, the distance arithmetic section 66 is able to determine which of the period from the timing t61 to the timing t62, the period from the timing t62 to the timing t63, the period from the timing t63 to the timing t64, the period from the timing t64 to the timing t65, the period from the timing t65 to the timing t66, the period from the timing t66 to the timing t67, and the period from the timing t67 to the timing t68 the reflected light pulse L1 has entered the photodiode PD in.

FIG. 27 illustrates an operation example of the distance arithmetic section 66.

First, as with the distance arithmetic section 16 according to the first embodiment, the distance arithmetic section 66 calculates the peak centroid value μ1 indicating the peak position in the histogram H1 on the basis of the histogram H1, and calculates the peak centroid value μ2′ indicating the peak position in the histogram H2 on the basis of the histogram H2 (steps S101 and S102). The peak centroid value μ1 is a value based on the counter code TDCCODE1, and the peak centroid value μ2′ is a value based on the counter code TDCCODE2.

Next, the distance arithmetic section 66 uses the following equation to convert the peak centroid value μ2′ from the value based on the counter code TDCCODE2 into a value based on the counter code TDCCODE1 to thereby calculate a peak centroid value μ2 (step S132).

$$µ2 = {µ2}^{′} \times ( tw 2 / tw 1 )$$

where tw1 represents a parameter indicating the bin width in the histogram H1. In other words, tw1 is a parameter indicating temporal resolution obtained in a case of using the counter code TDCCODE1. tw2 represents a parameter indicating the bin width in the histogram H2. In other words, tw2 is a parameter indicating temporal resolution obtained in a case of using the counter code TDCCODE2.

Next, the distance arithmetic section 66 checks whether the peak centroid values μ1 and μ2 satisfy the following relational expression (step S133).

$$µ2 - µ1 + ε > 0$$

where ε is expressible by the following expression.

$$ε = \vert ( 1 - tw 2 / tw 1 ) \times n \vert / 2$$

where n represents a parameter indicating the number of bins in the histograms H1 and H2.

In a case where the relational expression is satisfied in step S133 (“Y” in step S133), the distance arithmetic section 66 calculates the peak shift value θ by using the following expression (step S104).

$$θ = μ2 - μ1$$

Alternatively, in a case where the relational expression is not satisfied in step S133 (“N” in step S133), the distance arithmetic section 66 calculates the peak shift value θ by using the following expression (step S135).

$$θ = μ2 - μ1 + n \cdot ( tw 2 / tw 1 )$$

Next, the distance arithmetic section 66 calculates the offset ρ by using the following expression (step S136).

$$ρ = int ( θ / \vert ( 1 - tw 2 / tw 1 ) \times n \vert ) \times n$$

where int represents a function for obtaining an integer of an argument.

Next, the distance arithmetic section 66 calculates the distance value D by using the following expression (step S137).

$$D = ( μ1 + ρ ) \times Δ D 1$$

where ΔD1 represents a parameter for converting the bin width of the histogram H1 into the distance value.

The process thus ends.

In the following, the process performed by the distance arithmetic section 66 illustrated in FIG. 27 will be specifically described with reference to some examples.

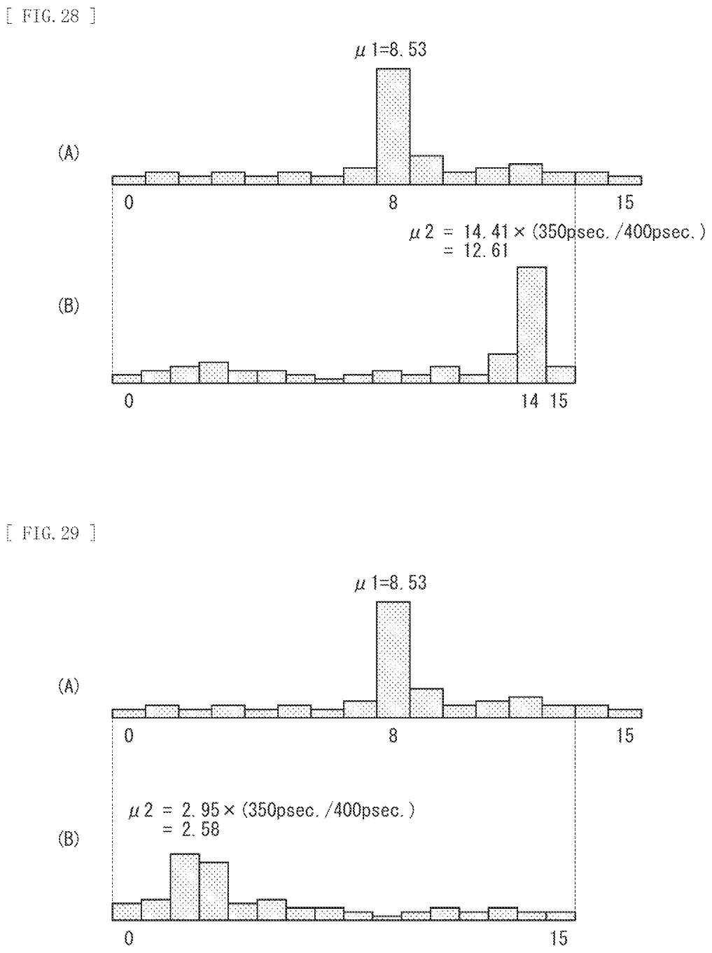

FIG. 28 illustrates an example of the histograms H1 and H2 obtained by the photodetection system 2. First, the distance arithmetic section 66 calculates the peak centroid value μ1 on the basis of the histogram H1 and calculates the peak centroid value μ2′ on the basis of the histogram H2 (steps S101 and S102). In this example, the peak centroid value μ1 is “8.53”, and the peak centroid value μ2′ is “14.41”.

Next, the distance arithmetic section 66 calculates the peak centroid value μ2 by converting the peak centroid value μ2′ from the value based on the counter code TDCCODE2 into the value based on the counter code TDCCODE1 as follows (step S132).

$$μ2 = 14.41 \times ( 350 psec . / 400 psec . ) = 12.61$$

Next, the distance arithmetic section 66 checks whether the peak centroid values μ1 and μ2 satisfy the relational expression in step S133 (step S133). In this example, the bin width tw1 in the histogram H1 is “400 psec.”, the bin width tw2 in the histogram H2 is “350 psec.”, and the number n of bins in the histograms H1 and H2 is “16”. Therefore, the parameter ε is “1”. Accordingly, the distance arithmetic section 66 calculates “μ2−μ1+ε” as follows.

$$μ2 - μ1 + ε = 12.61 - 8.53 + 1 = 5.08$$

Therefore, in this example, the relational expression in step S133 is satisfied. The distance arithmetic section 66 calculates the peak shift value θ as follows (step S104).

$$θ = 12.61 - 8.53 = 4.08$$

Next, the distance arithmetic section 66 calculates the offset ρ as follows (step S136).

$$\begin{matrix}ρ = int ( 4.08 / \vert ( 1 - 350 psec . / 400 psec . ) \times 16 \vert ) \times 16 \\ = 32\end{matrix}$$

Next, the distance arithmetic section 66 calculates the distance value D as follows (step S137).

$$D = ( 8.53 + 32 ) \times 0.06 = 2.43 [ m ]$$

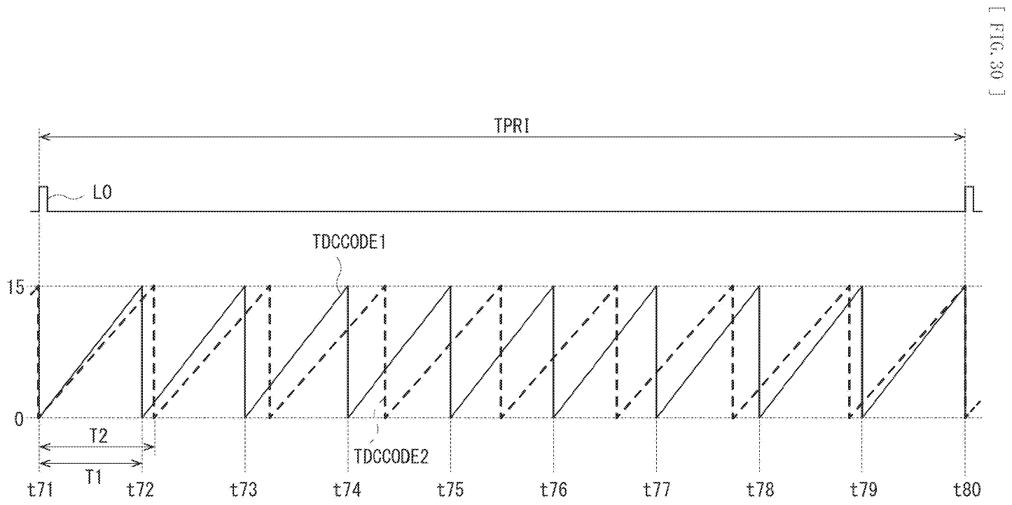

FIG. 29 illustrates another example of the histograms H1 and H2 obtained by the photodetection system 2. First, the distance arithmetic section 66 calculates the peak centroid value μ1 on the basis of the histogram H1 and calculates the peak centroid value μ2 on the basis of the histogram H2 (steps S101 and S102). In this example, the peak centroid value μ1 is “8.53”, and the peak centroid value μ2 is “2.95”.

Next, the distance arithmetic section 66 calculates the peak centroid value μ2 by converting the peak centroid value μ2′ from the value based on the counter code TDCCODE2 into the value based on the counter code TDCCODE1 as follows (step S132).

$$μ2 = 2.95 \times ( 350 psec . / 400 psec . ) = 2.58$$

Next, the distance arithmetic section 66 checks whether the peak centroid values μ1 and μ2 satisfy the relational expression in step S133 (step S133). The distance arithmetic section 66 calculates “μ2−μ1+ε” as follows.

$$μ2 - μ1 + ε = 2.58 - 8.53 + 1 = - 4.95$$

Therefore, in this example, the relational expression in step S133 is not satisfied. The distance arithmetic section 66 calculates the peak shift value θ as follows (step S135).

$$θ = 2.58 - 8.53 + 16 \times ( 350 psec . / 400 psec . ) = 8.05$$

Next, the distance arithmetic section 66 calculates the offset ρ as follows (step S136).

$$\begin{matrix}ρ = int ( 8.05 / \vert ( 1 - 350 psec . / 400 psec . ) \times 16 \vert ) \times 16 \\ = 64\end{matrix}$$

Next, the distance arithmetic section 66 calculates the distance value D as follows (step S137).

$$D = ( 8.53 + 64 ) \times 0.06 = 4.35 [ m ]$$

As described above, in the photodetection system 2, as illustrated in FIG. 26, the first code (the counter code TDCCODE1) is caused to change at a first time interval during the first period (the period T1), and the second code (the counter code TDCCODE2) is caused to change at a second time interval different from the first time interval during the second period (the period T2). The first time interval and the second time interval are set by the frequency of the clock signal CLK, and are thus settable to various values. Accordingly, it is possible for the photodetection system 2 to be increased in flexibility of operation as compared with the photodetection system 1 according to the first embodiment, for example.

As described above, according to the present embodiment, the first code changes at the first time interval during the first period and the second code changes at the second time interval during the second period. This makes it possible to increase the flexibility of operation.

### Modification Example 2-1

In the above-described embodiment, as illustrated in FIG. 24, the two clock signal generators 61 and 62 and the selector 63 are provided. The clock signal generator 61 generates the clock signal of 2.5 GHz, and the clock signal generator 62 generates the clock signal of 2.86 GHz. Then, during the sub-frame period SF1, the selector 63 outputs the clock signal generated by the clock signal generator 61 as the clock signal CLK, and during the sub-frame period SF2, the selector 63 outputs the clock signal generated by the clock signal generator 62 as the clock signal CLK. This configuration is not limitative. Alternatively, for example, as in the case of first embodiment (FIG. 6), the single clock signal generator 31 may be provided and the clock signal generator 31 may, on the basis of the control signal Sfreq, generate the clock signal CLK of 2.5 GHz during the sub-frame period SF1 and generate the clock signal CLK of 2.86 GHz during the sub-frame period SF2.

### Modification Example 2-2

In the above-described embodiment, the update cycle of the counter code TDCCODE1 is set to 400 psec. in the sub-frame period SF1 and the update cycle of the counter code TDCCODE2 is set to 350 psec. in the sub-frame period SF2; however, this is not limitative. In the following, the present modification example will be described with reference to some examples.

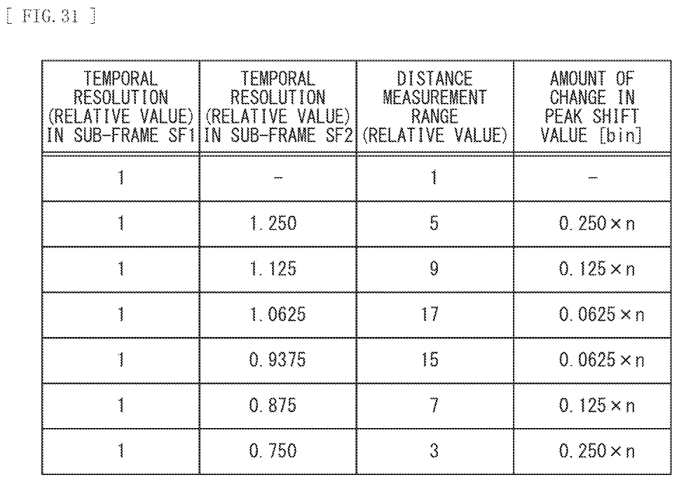

FIG. 30 illustrates an operation example of the photodetection system 2 according to the present modification example. In this example, the TDC section 52 sets the update cycle of the counter code TDCCODE1 to 400 psec. in the sub-frame period SF1 and sets the update cycle of the counter code TDCCODE2 to 450 psec. in the sub-frame period SF2. In other words, the temporal resolution in the sub-frame period SF1 is 400 psec., and the temporal resolution in the sub-frame period SF2 is 450 psec. The temporal resolution in the sub-frame period SF2 is 9/8 times the temporal resolution in the sub-frame period SF2. The counter code TDCCODE1 circulates nine times during the unit exposure period TPRI, and the counter code TDCCODE2 circulates eight times during the unit exposure period TPRI. As described above, the counter code TDCCODE2 may have a longer update cycle than the counter code TDCCODE1.

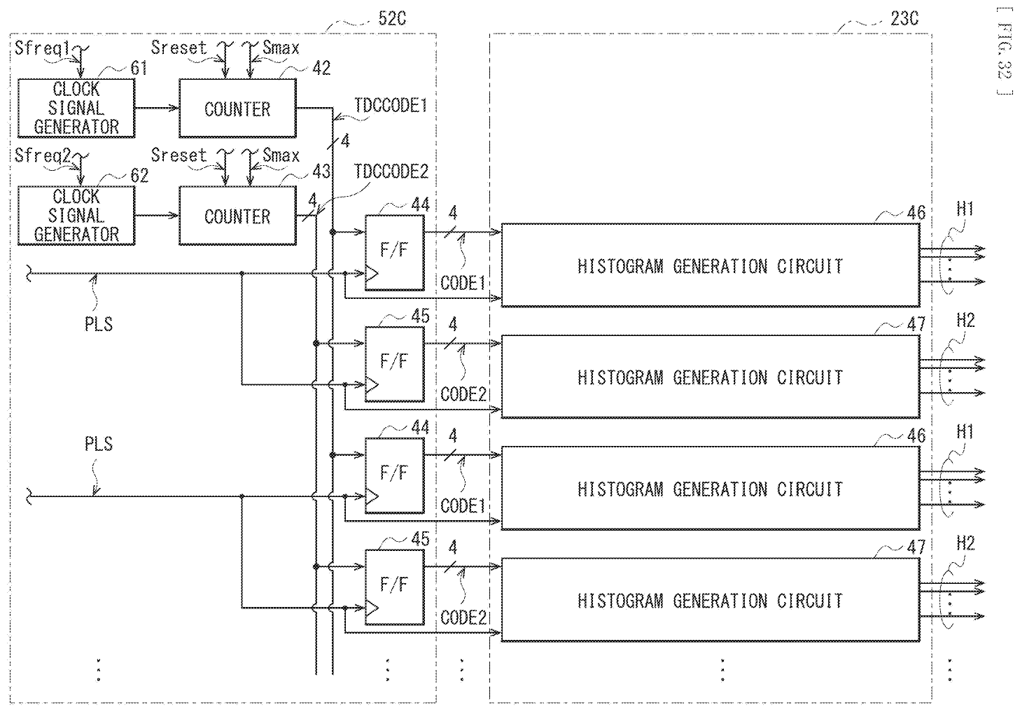

FIG. 31 illustrates amounts of change in the peak shift value and the distance measurement range in a case where the temporal resolution in the sub-frame period SF1 and the temporal resolution in the sub-frame period SF2 are set to various values. Relative values are used for the distance measurement range in such a manner that the distance measurement range is set to “1” in a case of using only the counter code TDCCODE1 without using the counter code TDCCODE2.

For example, in a case where the temporal resolution in the sub-frame period SF2 is set to 1.125 times (9/8 times) the temporal resolution in the sub-frame period SF1 as illustrated in FIG. 30, it is possible to make the distance measurement range nine times that in the case of using only the counter code TDCCODE1 without using the counter code TDCCODE2. The amount of change in peak shift value is “2” in a case where the number n of bins in the histograms H1 and H2 is set to “16”.

As a ratio between the temporal resolution in the sub-frame period SF1 and the temporal resolution in the sub-frame period SF2 is set to be closer to 1, the distance measurement range increases whereas the amount of change in peak shift value decreases. If the amount of change in peak shift value decreases, it becomes difficult to distinguish among the distance ranges. Even in this case, it is possible to make it easier to distinguish among the distance ranges by increasing the number n of bins in the histograms H1 and H2.

### Modification Example 2-3

In the above-described embodiment, the sub-frame periods SF1 and SF2 are set, the histogram H1 is generated during the sub-frame period SF1, and the histogram H2 is generated during the sub-frame period SF2; however, this is not limitative. Alternatively, as in Modification Example 1-3, for example, the histograms H1 and H2 may be simultaneously generated without setting he sub-frame period SF1 or SF2. In the following, a detailed description will be given of a TDC section 52C according to the present modification example.

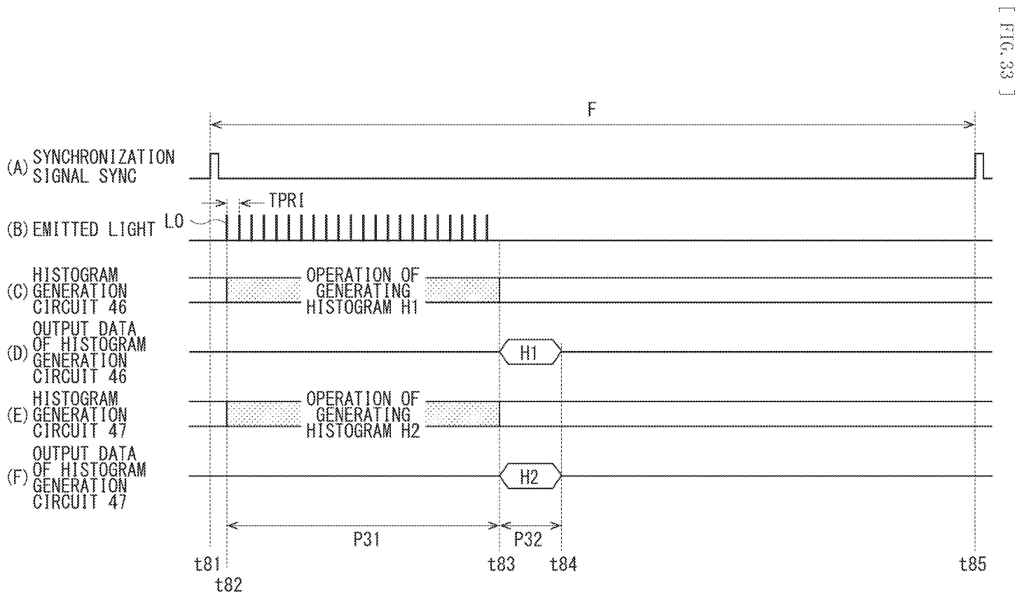

FIG. 32 illustrates a configuration example of the TDC section 52C and the histogram generation section 23C. The TDC section 52C includes the clock signal generators 61 and 62, the counters 42 and 43, the plurality of flip-flops 44, and the plurality of flip-flops 45.

In this example, the clock signal generator 61 generates a clock signal of 2.5 GHz on the basis of the control signal Sfreq1. The counter 42 generates the counter code TDCCODE1 by performing the counting operation on the basis of the clock signal generated by the clock signal generator 61. The counter 42 performs the counting operation in such a manner that the counter code TDCCODE1 has a value that circulates in the range from “0” to “15”.

In this example, the clock signal generator 62 generates a clock signal of 2.86 GHz on the basis of the control signal Sfreq2. The counter 43 generates the counter code TDCCODE2 by performing the counting operation on the basis of the clock signal generated by the clock signal generator 62. The counter 43 performs the counting operation in such a manner that the counter code TDCCODE2 has a value that circulates in the range from “0” to “15”.

The pulse signal PLS generated by the macropixel MP is supplied to the flip-flops 44 and flip-flops 45.

Each of the plurality of flip-flops 44 generates the timing code CODE1 of multiple bits by sampling the counter code TDCCODE1 of multiple bits on the basis of the rising edge of the pulse signal PLS.

Each of the plurality of flip-flops 45 generates the timing code CODE2 of multiple bits by sampling the counter code TDCCODE2 of multiple bits on the basis of the rising edge of the pulse signal PLS.

The histogram generation section 23C includes the plurality of histogram generation circuits 46 and the plurality of histogram generation circuits 47.

FIG. 33 illustrates an operation example of the photodetection system 2 according to the present modification example. (A) of FIG. 33 illustrates the waveform of the synchronization signal SYNC. (B) of FIG. 33 illustrates the waveform of light emitted from the light-emitting section 12. (C) of FIG. 33 illustrates operation of the histogram generation circuit 46. (D) of FIG. 33 illustrates output data of the histogram generation circuit 46. (E) of FIG. 33 illustrates operation of the histogram generation circuit 47. (F) of FIG. 33 illustrates output data of the histogram generation circuit 48.

A frame period F is started by a pulse of the synchronization signal SYNC at a timing t81 ((A) of FIG. 33). The control section 24 uses the control signal Sfreq1 to instruct the clock signal generator 61 of the TDC section 52C to generate the clock signal of 2.5 GHz, and uses the control signal Smax to instruct the counter 42 to perform the counting operation in the range of “0” or more and “15” or less. In addition, the control section 24 uses the control signal Sfreq2 to instruct the clock signal generator 62 of the TDC section 52C to generate the clock signal of 2.86 GHz, and uses the control signal Smax to instruct the counter 43 to perform the counting operation in the range of “0” or more and “15” or less.

Next, during a period from a timing t82 to a timing t83 (the exposure period P31), the light-emitting section 12 repeatedly emits the light pulse L0 in a predetermined cycle in units of the unit exposure period TPRI ((B) of FIG. 33). The reflected light pulse L1 based on the light pulse L0 repeatedly enters the photodetection system 1. The macropixel MP generates the pulse signal PLS by detecting the reflected light pulses L1. The pulse signal PLS includes a plurality of pulses generated each time the macropixel MP detects the reflected light pulse L1.

The clock signal generator 61 of the TDC section 52C generates the clock signal of the 2.5 GHz. The counter 42 performs the counting operation in such a manner that the counter code TDCCODE has a value that circulates in the range of “0” or more and “15” or less. The flip-flop 44 repeatedly generates the timing code CODE1 corresponding to the detection timing of the reflected light pulse L1 in the macropixel MP by sampling the counter code TDCCODE1 on the basis of the pulse signal PLS. During the exposure period P31, the histogram generation circuit 46 generates the histogram H1 on the basis of the plurality of timing codes CODE1 ((C) of FIG. 33).

In a similar way, the clock signal generator 62 of the TDC section 52C generates the clock signal of the 2.86 GHZ. The counter 43 performs the counting operation in such a manner that the counter code TDCCODE2 has a value that circulates in the range of “0” or more and “15” or less. The flip-flop 45 repeatedly generates the timing code CODE2 corresponding to the detection timing of the reflected light pulse L1 in the macropixel MP by sampling the counter code TDCCODE2 on the basis of the pulse signal PLS. During the exposure period P31, the histogram generation circuit 47 generates the histogram H2 on the basis of the plurality of timing codes CODE2 ((E) of FIG. 33).

Next, during a period from the timing t83 to a timing t84 (the output period P32), the histogram generation circuit 46 outputs the generated histogram H1 to the distance arithmetic section 16 ((D) of FIG. 33), and the histogram generation circuit 47 outputs the generated histogram H2 to the distance arithmetic section 16 ((F) of FIG. 33).

Thereafter, at a timing t85, the frame period F ends and a new frame period F starts. The photodetection system 2 repeats the operations performed from the timing t81 to the timing t85 at a predetermined frame rate.

The operations of the counters 42 and 43 performed during the unit exposure period TPRI are similar to those in the above-described second embodiment (FIG. 26), for example. In addition, the operation of the distance arithmetic section 66 is similar to that in the above-described embodiment (FIGS. 27 to 29), for example.

### Other Modification Examples

Moreover, two or more of the above-described modification examples may be applied in combination.

### 3. Implementation Examples

Next, a description will be given of implementation examples of the photodetection system 1 according to the first embodiment. It is to be noted that the same applies to implementation examples of the photodetection system 2 according to the second embodiment.

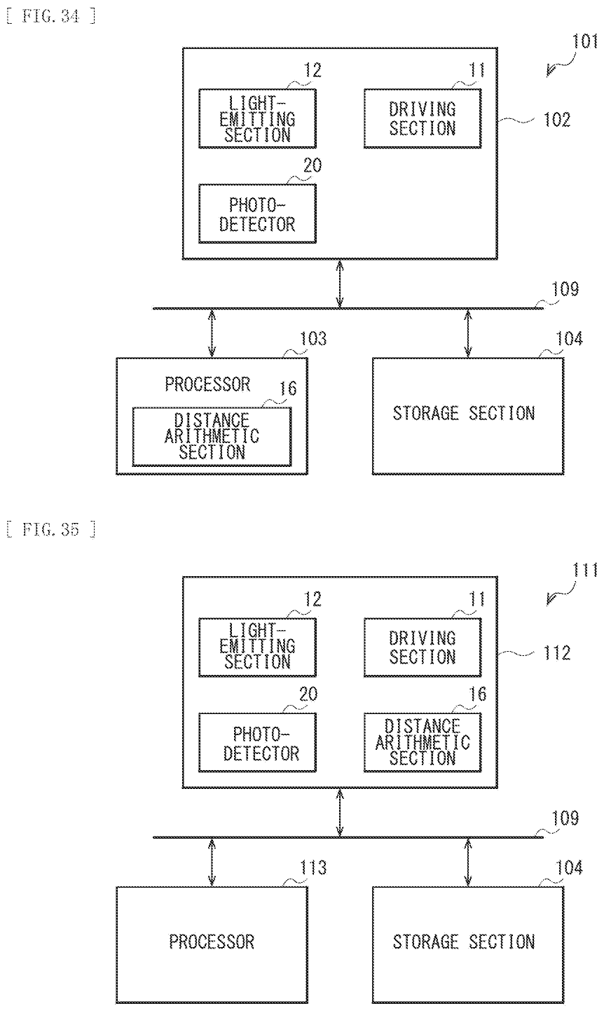

FIG. 34 illustrates a configuration example of a photodetection system 101 in which the photodetection system 1 is implemented. The photodetection system 101 includes a module 102, a processor 103, and a storage section 104. The module 102, the processor 103, and the storage section 104 are configured to be coupled to a bus 109 and to transmit and receive data via the bus 109. The module 102 includes the driving section 11, the light-emitting section 12, the collimator lens 13, the condenser lens 14, the band-pass filter 15, and the photodetector 20. Illustrations of the collimator lens 13, the condenser lens 14, and the band-pass filter 15 are omitted from FIG. 34. The processor 103 is configured to control operation of the photodetection system 101. The processor 103 includes the distance arithmetic section 16. Examples of the storage section 104 include a memory. The module 102 supplies the histograms H1 and H2 to the distance arithmetic section 16 of the processor 103, and the distance arithmetic section 16 generates the distance data DT on the basis of the histograms H1 and H2.

In this example, the distance arithmetic section 106 of the processor 103 calculates the distance value; however, this is not limitative. For example, a processing unit such as a GPU (Graphics Processing Unit), a FPGA (Field Programmable Gate Array), or a DSP (Digital Signal Processor) may be coupled via the bus 109, and the processing unit may calculate the distance value.

FIG. 35 illustrates a configuration example of another photodetection system 111 in which the photodetection system 1 is implemented. The photodetection system 111 includes a module 112, a processor 113, and the storage section 104. The module 112 includes the driving section 11, the light-emitting section 12, the collimator lens 13, the condenser lens 14, the band-pass filter 15, the photodetector 20, and the distance arithmetic section 16. The processor 113 is configured to control operation of the photodetection system 111. For example, the processor 113 is able to acquire, from the module 112, the histograms H1 and H2 and the distance data DT generated by the distance arithmetic section 16.

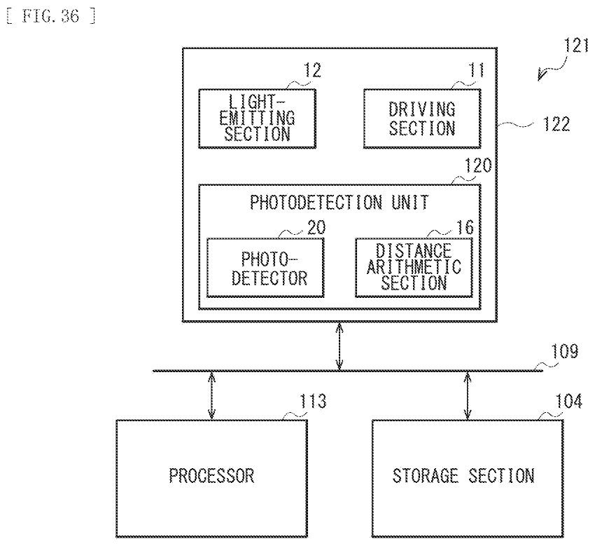

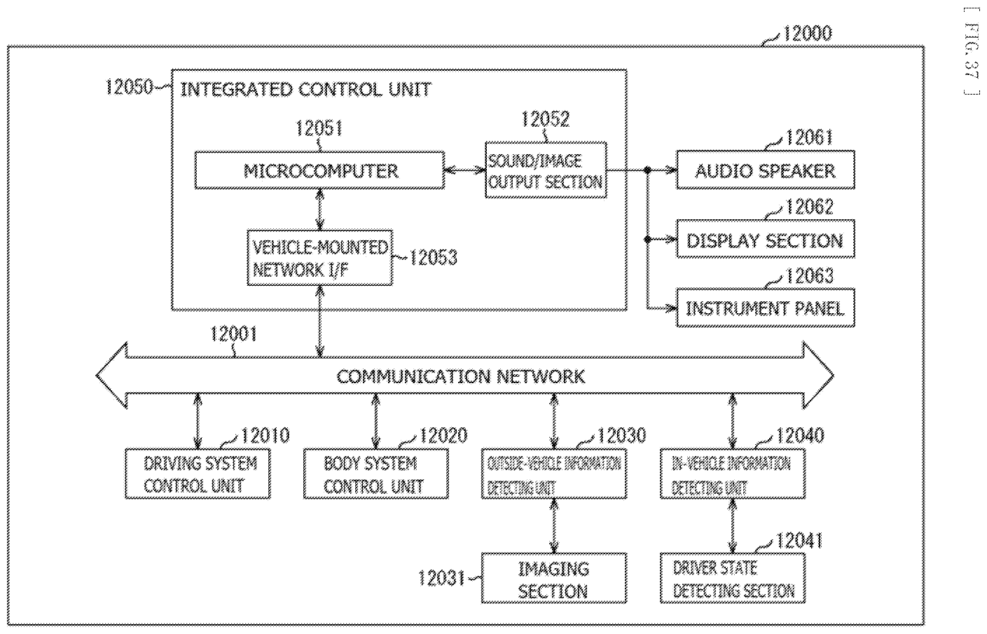

FIG. 36 illustrates a configuration example of another photodetection system 121 in which the photodetection system 1 is implemented. The photodetection system 121 includes a module 122, the processor 113, and the storage section 104. The module 122 includes the driving section 11, the light-emitting section 12, the collimator lens 13, the condenser lens 14, the band-pass filter 15, and a photodetection unit 120. The photodetection unit 120 includes the photodetector 20 and the distance arithmetic section 16. For example, the processor 113 is able to acquire, from the module 122, the histograms H1 and H2 and the distance data DT generated by the distance arithmetic section 16.

### 4. Example of Application to Mobile Body

The technology (the present technology) according to the present disclosure is applicable to a variety of products. For example, the technology according to the present disclosure may be achieved as a device mounted on any type of mobile body such as an automobile, an electric vehicle, a hybrid electric vehicle, a motorcycle, a bicycle, a personal mobility, an airplane, a drone, a vessel, or a robot.

FIG. 37 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 37, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 37, an audio speaker 12061, a display section 12062, and an instrument panel 12063 are illustrated as the output device. The display section 12062 may, for example, include at least one of an on-board display and a head-up display.

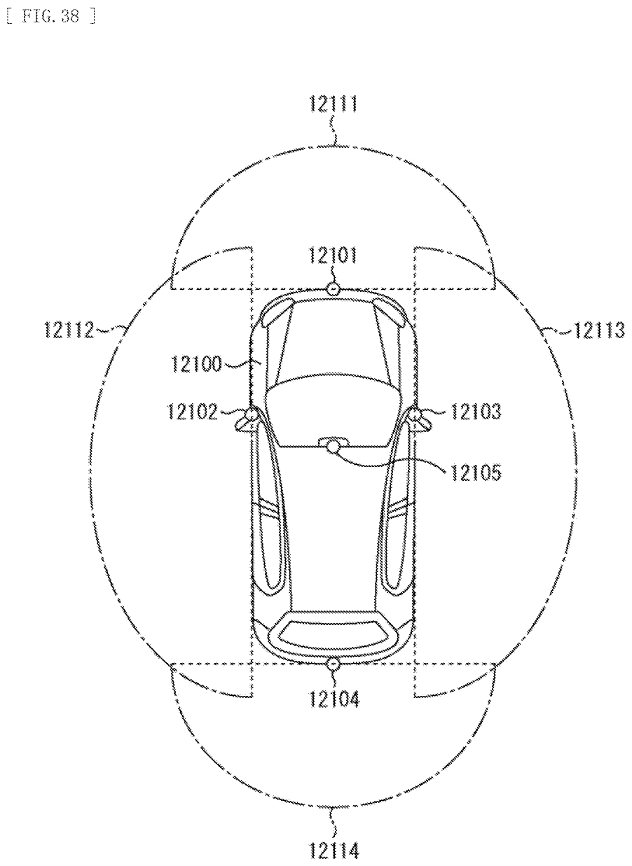

FIG. 38 is a diagram depicting an example of the installation position of the imaging section 12031.

In FIG. 38, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging sections 12101 and 12105 provided to the upper portion of the windshield within the interior of the vehicle are used mainly to detect a preceding vehicle, a pedestrian, an obstacle, a signal, a traffic sign, a lane, or the like.

Incidentally, FIG. 38 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The description has been given hereinabove of one example of the vehicle control system to which the technology according to the present disclosure may be applied. The technology according to the present disclosure may be applied to the imaging section 12031 among the configurations described above. This makes it possible for the vehicle control system 12000 to downsize the device while securing its distance measurement range. It is possible to widen the distance measurement range, which in turn makes it possible for the vehicle control system 12000 to implement, with high accuracy, collision avoidance or shock mitigation for vehicles, a following driving function based on vehicle-to-vehicle distance, a vehicle speed maintaining driving function, a warning function of collision of the vehicle, a warning function of deviation of the vehicle from a lane, and the like.

Although the present technology has been described above with reference to some embodiments, the modification examples, and specific application examples thereof, the present technology is not limited to these embodiments and the like, and may be modified in a variety of ways.

For example, in each of the above-described embodiments, the binary code is used as the counter code TDCCODE; however, this is not limitative. Alternatively, for example, a code of a code system other than the binary code, such as a Gray code, may be used. In addition, in the above-described example, the counter code TDCCODE is incremented; however, this is not limitative. Alternatively, for example, the counter code TDCCODE may be decremented.

It is to be noted that the effects described herein are merely illustrative and non-limiting, and other effects may be included.

It is to be noted that the present technology may also have the following configurations. According to the present technology having the following configurations, it is possible to reduce the circuit area.

(1)

A photodetection device including
a light-receiving element configured to detect a light pulse,
a conversion circuit configured to: generate a first code that sequentially changes over time during a first period having a first time length in a frame period and that circulates multiple times in units of the first period; generate a second code that sequentially changes over time during a second period having a second time length different from the first time length in the frame period and that circulates multiple times in units of the second period; generate a first timing code by sampling the first code in accordance with a detection timing of the light pulse; and generate a second timing code by sampling the second code in accordance with the detection timing, and
a histogram generation circuit configured to generate a first histogram related to the first timing code and generate a second histogram related to the second timing code.
   (2)

The photodetection device according to (1), in which
the frame period includes a first exposure period and a second exposure period,
the first exposure period includes a plurality of first unit exposure periods,
the first code circulates multiple times in units of the first period during each of the plurality of first unit exposure periods,
the second exposure period includes a plurality of second unit exposure periods, and
the second code circulates multiple times in units of the second period during each of the plurality of second unit exposure periods.
   (3)

The photodetection device according to (2), in which each of the plurality of first unit exposure periods has a time length equal to a time length of each of the plurality of second unit exposure periods.

(4)

The photodetection device according to (2) or (3), in which
the detection timing includes a first detection timing in the first exposure period and a second detection timing in the second exposure period, and
the conversion circuit is configured to
   generate the first timing code by sampling the first code in accordance with the first detection timing, and
   generate the second timing code by sampling the second code in accordance with the second detection timing.
      (5)

The photodetection device according to (1), in which
the frame period includes an exposure period,
the exposure period includes a plurality of unit exposure periods,
the first code circulates multiple times in units of the first period during each of the plurality of unit exposure periods, and
the second code circulates multiple times in units of the second period during each of the plurality of unit exposure periods.
   (6)

The photodetection device according to (5), in which
the detection timing includes a first detection timing in the exposure period, and
the conversion circuit is configured to
   generate the first timing code by sampling the first code in accordance with the first detection timing, and
   generate the second timing code by sampling the second code in accordance with the first detection timing.
      (7)

The photodetection device according to any one of (1) to (6), in which the number of values that the first code can take on during the first period is different from the number of values that the second code can take on during the second period.

(8)

The photodetection device according to any one of (1) to (6), in which
the first code changes at a first time interval during the first period, and
the second code changes at a second time interval during the second period, the second time interval being different from the first time interval.
   (9)

The photodetection device according to any one of (1) to (8), further including an arithmetic circuit configured to calculate the detection timing on the basis of the first histogram and the second histogram.

(10)

The photodetection device according to (9), in which the arithmetic circuit is configured to calculate a first representative value of the first timing code on the basis of the first histogram and calculate a second representative value of the second timing code on the basis of the second histogram, and is configured to calculate the detection timing on the basis of a difference between the first representative value and the second representative value.

(11)

The photodetection device according to (9), in which the arithmetic circuit is configured to calculate the detection timing by calculating a degree of similarity between the first histogram and the second histogram while changing a relative positional relationship between the first histogram and the second histogram.

(12)

The photodetection device according to any one of (9) to (11), in which
the light pulse includes a pulse as a resultant of reflection, by a detection target, of a light pulse emitted from a light-emitting element, and
the arithmetic circuit is configured to calculate a distance from the photodetection device to the detection target on the basis of the detection timing calculated.
   (13)

A photodetection system including
a light-emitting element configured to emit a first light pulse,
a light-receiving element configured to detect a second light pulse corresponding to the first light pulse,
a conversion circuit configured to: generate a first code that sequentially changes over time during a first period having a first time length in a frame period and that circulates multiple times in units of the first period; generate a second code that sequentially changes over time during a second period having a second time length different from the first time length in the frame period and that circulates multiple times in units of the second period; generate a first timing code by sampling the first code in accordance with a detection timing of the second light pulse; and generate a second timing code by sampling the second code in accordance with the detection timing, and
a histogram generation circuit configured to generate a first histogram related to the first timing code and generate a second histogram related to the second timing code.
   (14)

A photodetection method including:
emitting a first light pulse;
detecting a second light pulse corresponding to the first light pulse;
generating a first code that sequentially changes over time during a first period having a first time length in a frame period and that circulates multiple times in units of the first period;
generating a second code that sequentially changes over time during a second period having a second time length different from the first time length in the frame period and that circulates multiple times in units of the second period;
generating a first timing code by sampling the first code in accordance with a detection timing of the second light pulse;
generating a second timing code by sampling the second code in accordance with the detection timing; and
generating a first histogram related to the first timing code, and generating a second histogram related to the second timing code.

The present application claims the benefit of Japanese Priority Patent Application JP2021-108122 filed with the Japan Patent Office on Jun. 29, 2021, the entire contents of which are incorporated herein by reference.

It should be understood by those skilled in the art that various modifications, combinations, sub-combinations and alternations may occur depending on design requirements and other factors insofar as they are within the scope of the appended claims or the equivalents thereof.

1. A photodetection device comprising
a light-receiving element configured to detect a light pulse,
a conversion circuit configured to: generate a first code that sequentially changes over time during a first period having a first time length in a frame period and that circulates multiple times in units of the first period; generate a second code that sequentially changes over time during a second period having a second time length different from the first time length in the frame period and that circulates multiple times in units of the second period; generate a first timing code by sampling the first code in accordance with a detection timing of the light pulse; and generate a second timing code by sampling the second code in accordance with the detection timing, and
a histogram generation circuit configured to generate a first histogram related to the first timing code and generate a second histogram related to the second timing code.

2. The photodetection device according to claim 1, wherein
the frame period includes a first exposure period and a second exposure period,
the first exposure period includes a plurality of first unit exposure periods,
the first code circulates multiple times in units of the first period during each of the plurality of first unit exposure periods,
the second exposure period includes a plurality of second unit exposure periods, and
the second code circulates multiple times in units of the second period during each of the plurality of second unit exposure periods.

3. The photodetection device according to claim 2, wherein each of the plurality of first unit exposure periods has a time length equal to a time length of each of the plurality of second unit exposure periods.

4. The photodetection device according to claim 2, wherein
the detection timing includes a first detection timing in the first exposure period and a second detection timing in the second exposure period, and
the conversion circuit is configured to
generate the first timing code by sampling the first code in accordance with the first detection timing, and
generate the second timing code by sampling the second code in accordance with the second detection timing.

5. The photodetection device according to claim 1, wherein
the frame period includes an exposure period,
the exposure period includes a plurality of unit exposure periods,
the first code circulates multiple times in units of the first period during each of the plurality of unit exposure periods, and
the second code circulates multiple times in units of the second period during each of the plurality of unit exposure periods.

6. The photodetection device according to claim 5, wherein
the detection timing includes a first detection timing in the exposure period, and
the conversion circuit is configured to
generate the first timing code by sampling the first code in accordance with the first detection timing, and
generate the second timing code by sampling the second code in accordance with the first detection timing.

7. The photodetection device according to claim 1, wherein a number of values that the first code can take on during the first period is different from a number of values that the second code can take on during the second period.

8. The photodetection device according to claim 1, wherein
the first code changes at a first time interval during the first period, and
the second code changes at a second time interval during the second period, the second time interval being different from the first time interval.

9. The photodetection device according to claim 1, further comprising an arithmetic circuit configured to calculate the detection timing on a basis of the first histogram and the second histogram.

10. The photodetection device according to claim 9, wherein the arithmetic circuit is configured to calculate a first representative value of the first timing code on a basis of the first histogram and calculate a second representative value of the second timing code on a basis of the second histogram, and is configured to calculate the detection timing on a basis of a difference between the first representative value and the second representative value.

11. The photodetection device according to claim 9, wherein the arithmetic circuit is configured to calculate the detection timing by calculating a degree of similarity between the first histogram and the second histogram while changing a relative positional relationship between the first histogram and the second histogram.

12. The photodetection device according to claim 9, wherein
the light pulse comprises a pulse as a resultant of reflection, by a detection target, of a light pulse emitted from a light-emitting element, and
the arithmetic circuit is configured to calculate a distance from the photodetection device to the detection target on a basis of the detection timing calculated.

13. A photodetection system comprising
a light-emitting element configured to emit a first light pulse,
a light-receiving element configured to detect a second light pulse corresponding to the first light pulse,
a conversion circuit configured to: generate a first code that sequentially changes over time during a first period having a first time length in a frame period and that circulates multiple times in units of the first period; generate a second code that sequentially changes over time during a second period having a second time length different from the first time length in the frame period and that circulates multiple times in units of the second period; generate a first timing code by sampling the first code in accordance with a detection timing of the second light pulse; and generate a second timing code by sampling the second code in accordance with the detection timing, and
a histogram generation circuit configured to generate a first histogram related to the first timing code and generate a second histogram related to the second timing code.

14. A photodetection method comprising:
emitting a first light pulse;
detecting a second light pulse corresponding to the first light pulse;
generating a first code that sequentially changes over time during a first period having a first time length in a frame period and that circulates multiple times in units of the first period;
generating a second code that sequentially changes over time during a second period having a second time length different from the first time length in the frame period and that circulates multiple times in units of the second period;
generating a first timing code by sampling the first code in accordance with a detection timing of the second light pulse;
generating a second timing code by sampling the second code in accordance with the detection timing; and
generating a first histogram related to the first timing code, and generating a second histogram related to the second timing code.
